(19) United States
(12) Patent Application Publication
(10) Pub. No.: US 2008/0091681 A1
(43) Pub. Date: Apr. 17, 2008

(54) ARCHITECTURE FOR UNIFIED THREAT MANAGEMENT

(76) Inventors: Saket Dwivedi, Uttar Pradesh (IN); Harsha R. Angeri, Bangalore (IN); Vikram J. Arora, Bangalore (IN)

Correspondence Address: HONEYWELL INTERNATIONAL INC., 101 COLUMBIA ROAD, P O BOX 2245, MORRISTOWN, NJ, 07962-2245, US

(21) Appl. No.: 11/871,611

(22) Filed: Oct. 12, 2007

Related U.S. Application Data
(60) Provisional application No. 60/851,792, filed on Oct. 12, 2006.

(51) Int. Cl. G06F 17/30; G06F 21/00

(52) U.S. Cl. 707/9; 726/21; 707/E17.105

(57) ABSTRACT

A security architecture has an event analysis engine that acquires several tangible actions. The occur in an action space of an organization, and relate to unauthorized access to assets and reproduction of information. The event analysis engine evaluates the acquired actions based on the information stored in the database and in the context of past actions which have occurred, and determines a suitable response to the acquired action based on the evaluation.

### RELATED APPLICATIONS

The present application claims the benefit of U.S. Provisional Application Ser. No. 60/851,792 filed on Oct. 12, 2006.

### TECHNICAL FIELD

The present application discloses an architecture that merges physical and logical security. Physical security, for example, protects access to physical assets, and such physical protection might be provided by a control system that restricts access to buildings and/or to the spaces within buildings. Logical security, for example, protects access to information technology, and such logical protection might be provided by a control system that restricts access to databases and other information.

### BACKGROUND

In recent times, the focus on security has increased many folds. Spending on residential security, enterprise security, and National security has increased dramatically. For example, the U.S. Government has issued Homeland Security Presidential Directive 12 which necessitates all Federal Government employees to use secure identification cards for access to both physical assets and logical assets. As to enterprise security, a survey conducted by the International Security Management Association (ISMA) reveals that 54% of respondents had enhanced their focus on security, and half of them had increased security of their related investments as well.

Logically, physical security primarily protects people and physical infrastructures, while logical security protects “soft” assets such as information. In recent times, the asset bases of organizations have changed from being primarily physical based (buildings, equipment, machinery, people) to being primarily information based (data files stored on computers, important mail on PDAs, etc.) This change in asset base has led to a change in the nature of the threats that organizations face today. Violations of physical security do not just pose a risk to physical assets anymore; they also facilitate violations of information security, and vice versa.

Some solutions have been developed to address threats to physical and logical security, such as the introduction of smart cards and biometrics to regulate physical and network access. However, these solutions do not completely address many risk scenarios.

One example of a risk scenario is the person who tailgates a genuine accessor into a room, finds an unattended and unlocked PC (common in most organizations), and steals information. Even the use of smart cards and/or biometric readers cannot entirely avoid this risk scenario—users often leave their smart cards in the card reading slot while going for a coffee—in effect, the computer is unlocked and unattended.

Another example of a risk scenario is the person who breaks into a building or room at night or during a holiday and who uses previously acquired passwords to steal information from unattended workstations. Again, even the use of smart cards and/or biometric readers cannot entirely avoid this risk scenario.

The evolution of Enterprise Risk Management (ERM) has led to a shift in the way organizations approach such risks. ERM methodologies enable companies to view enterprise risk holistically rather than looking at various components individually. The Commission of Sponsoring Organizations of the Treadway Commission (COSO) has issued guidance on the implementation of a consistent ERM framework, which an organization can use to assess, evaluate, and prioritize the risks facing it and to develop a suitable strategy to counter these risks.

Also, there has been consideration given to security convergence, the merging of physical and IT security, physical and logical security integration, and several other similar topics. The term security convergence has been frequently used to address such endeavors, though the term means different things to different people. The survey at ISMA revealed that different respondents had completely different perceptions of security convergence. Several VoCs conducted across the U.S. and India confirmed these different perceptions. However, the general understanding is that it refers to the integration of physical and logical security.

However, separate physical and network security vendors are still typically required so that separate contracts for maintenance of the two systems need to be awarded. Interfacing with both of the physical and logical security systems is still not a low risk approach. It would be more prudent to instead develop one system which oversees both physical and logical security.

No previous work has considered the mapping of physical and logical coordinates so that one system can oversee both physical and logical security (access control).

A fresh customer survey has been conducted by us covering several companies across India and the United States. To conduct this survey, a hypothesis sheet, shown in FIGS. 1A and 1B, was developed and used to develop a questionnaire covering current customer security infrastructures, problem areas which current solutions are not able to address, desired improvements, trends in technology that are affecting customer buying behavior, shifts in buying trends, etc.

The responses to this questionnaire were analyzed and yielded several conclusions. For example, there are several factors which are driving security convergence. Some of these factors include (i) a shift in the primary asset base of the organization from a physical base to an information technology base, coupled with a failure of physical security to offer adequate protection for information technology assets, (ii) regulatory pressures from such laws as Sarbanes Oxley and the Health Insurance Portability and Accountability Act (HIPAA), etc., (iii) technology trends such as Internet Protocol (IP) convergence, Smart cards, etc., (iv) cost reductions, (v) shifts in outlook as evidenced by educational convergence and programs addressing both corporate and information security, and (vi) threat convergence such as a violation of physical/logical security leading to a violation of the other. IP Convergence implies carrying different types of traffic such as voice, video, data, and images over a single network based on the Internet Protocol [IP].

It was also realized that there might be intrusion scenarios in which a physical security violation enables an intruder to gain (unauthorized) access to an information asset such as one stored on a desktop PC or a laptop/PDA.

Immediately below is a table of various intrusion scenario examples. Although these scenarios use the example of a laptop for discussion, it can be noted that they could involved any other data carrying device, including but not limited to, USB drives, Compact Discs, and, theoretically, even desktop computers.

| Scenario | Per- | Of- | Net- | |
|---|---|---|---|---|
| # | son | fice | work | |
| 1 | n | n | n | Physically move the laptop by |
| | | | | gaining entry into the house |
| 2 | n | n | y | Physically move the laptop by |
| | | | | gaining entry into the house |
| | | | | and breaking into the system |
| 3 | n | y | n | Physically move the laptop and |
| | | | | get out of the office |
| 4 | n | y | y | Remotely login through the |
| | | | | firewall and takeout the files |
| 5 | y | n | n | Forcibly snatch the laptop |
| 6 | y | n | y | Remotely login through |
| | | | | internet and get out the files |
| 7 | y | y | n | Break into the office and |
| | | | | forcibly snatch the laptop |
| 8 | y | y | y | Download an application that |
| | | | | gets out the files |

In the first scenario, a person, such as an employee, is not present near the asset (e.g., the asset may be a company laptop containing critical information), the asset is not in the office (e.g., the asset may be unattended in the person's house), and the person has not logged onto the network. An intruder who breaks into the person's house can physically remove the asset (e.g., laptop).

In the second scenario, a person, such as an employee, is not present near the asset (e.g., the asset may be a company laptop containing critical information), the asset is not in the office (e.g., the asset may be unattended in the person's house), and the person has logged onto the network. An intruder who breaks into the person's house can access the corporate network through the unattended laptop.

In the third scenario, a person, such as an employee, is not present near the asset (e.g., the asset may be a company laptop containing critical information), the asset is in the office but is unattended by the person, and the person has not logged onto the network. An intruder can remove the asset from the office.

In the fourth scenario, a person, such as an employee, is not present near the asset (e.g., the asset may be a company laptop containing critical information), the asset is in the office but is unattended by the person, and the person has logged onto the network. An intruder can remotely log in to the network and remove files.

In the fifth scenario, a person, such as an employee, is present near the asset (e.g., the asset may be a company laptop containing critical information), the asset is not in the office, and the person has not logged onto the network. The asset can be forcibly taken away from the person.

In the sixth scenario, a person, such as an employee, is present near the asset (e.g., the asset may be a company laptop containing critical information), the asset is not in the office, and the person has logged onto the network. An intruder can log into the network such as through the Internet and remove files.

In the seventh scenario, a person, such as an employee, is present near the asset (e.g., the asset may be a company laptop containing critical information), the asset is in the office, and the person has not logged onto the network. An intruder can gain unauthorized entry into the office and forcibly take the asset away from the person.

In the eighth scenario, the person is working on his laptop in the office and is logged on to the network. An intruder can, over the network, steal the files stored on the computer.

Other scenarios and variations on these scenarios are possible.

On analysis, it can be seen that all of these scenarios have one loophole; the laptop does not “know” what is happening to it. It typically has only one mechanism to verify that the user is an authorized user before granting complete access. This mechanism is a user password or smart card swipe, both of which are transferable credentials. Consequently, it is possible (and common) to access information on the computer and/or network by impersonating the user. A solution is required to address this problem.

In addressing this problem, it is useful to recognize that physical authentication and logical authentication for the most part occur at different points in time. Hence, a series of events could lead to a compromise. Therefore, if the physical and logical presence of any object (including people) can be established at every instance in time when an access is required, then all of these scenarios can be solved.

In other words, the actual physical presence of the person logging onto a computer should be established each and every time that the person logs onto the computer. Once this presence is established, the detection of the event (e.g., login attempt) is enough to generate a suitable access revoke response whenever it is needed. Thus, an appropriate response can be provided based on the mapping of both physical and logical presence.

The following possibilities relating to the person-office-network matrix mentioned above can be considered.

In the first intrusion scenario, if the asset (e.g., laptop) is able to determine that a person (e.g., an intruder) who is physically carrying it away is not the actual owner, the asset can revoke access to the intruder when the intruder tries to log on.

Similarly, in the final scenario, if the asset (e.g., laptop) is able to determine that the authorized user is logged on and is currently working on the system, the asset could disallow exporting files and, thus, protect unauthorized data transfer.

Proposed herein is the concept of “Mapping”—so that assets can “determine” their users—and, accordingly, grant and/or revoke access. This mapping ensures that an asset (e.g., laptop, USB drive, CD drive, etc.) “understands” the physical and logical location of the person and, therefore, can make the appropriate decision. The concept of mapping is now described.

A logical coordinate can identify the position of a logical object (e.g., a computer, a folder/file on a computer, a USB drive, a CD ROM, or any element that can store or process data in electronic form) in the logical world. The logical world is the collection of all logical objects. For example, a logical coordinate identifies a desktop computer as uniquely belonging to a particular person. The logical coordinate may be any kind of unique identifier such that, preferably, no two logical coordinates ever identify the same object. This identifier, for example, can be similar to the GUID used by Windows applications.

A logical coordinate can alternatively or additionally identify the interface between a person and the logical world. This interface may be the person's password or smart card that the person knows or carries, although this interface is preferably something other than a password as the use of passwords create several problems and as passwords are more easily transferable. Biometrics are a good option for this interface. Alternatively or additionally, an RFID tag can be integrated with the person's access card coupled with a reader on the computer to provide this interface.

The physical coordinate refers to the geographic location of an entity (person and/or asset). The degree of detail to which a physical coordinate is defined depends on the context and requirements. For example, if an employee has swiped the employee's access card at room #4 on the 3rd floor of building A inside the premises of Organization B, the physical coordinate of the employee could be, for example, “Inside Main Campus | Building A ∥ 3^{rd} floor ∥ room #4.” Alternatively, if the employee is out of the office, the employee's physical coordinate could instead simply be, for example, “Outside Office” because that example may be sufficient to serve the purpose.

It may be noticed that, whereas more than one object may have the same physical coordinate (there may be numerous users of a PC who are “Out of Office” or all assets inside the same room may have the same PC), no two objects may have the same logical coordinate.

Accordingly, when mapping the physical and logical coordinates of the person with those of a resource, an effort is being made (i) to match the physical coordinate of the person with the physical coordinate of the resource (i.e., are the person and resource are located at the same place), (ii) to match the physical coordinate of the person with the logical coordinate of the person (i.e., is the person using his/her own credential to access a resource), (iii) to match the physical coordinate of the person with the logical coordinate of the resource (is the person authorized to access this resource from the particular physical location, which is useful in Mapping for remote log in), and (iv) to match the logical coordinate of the person with the logical coordinate of the resource (i.e., is the person with the given credentials permitted to access the resource identified by the logical coordinate).

It is proposed herein that every network port also possess unique physical and logical coordinates. Whenever a laptop is connected to a network port, the physical coordinate of the port can be assigned to that of the laptop. In this way, the physical coordinate of the laptop can be determined. The security architecture of the system 10 identifies all ports within the organization. Hence, if anyone tries to access the corporate network from outside the office, the architecture can immediately assign his/her PC as “Out of Office”. This concept can be expanded to include all the network ports in the extended organization—which includes, for example, the ports at the residences of employees carrying laptops, ports at vendors' facilities etc. If a CD or USB, or in general any data carrying device, is inserted into the laptop, the same physical coordinate can be assigned to that data carrying device as well. The logical coordinate of the port will identify the port in one cubicle, for example, as different from the port in a neighboring cubicle; the physical coordinates of the two ports can be the same—“Inside Mars Building |IV Floor | Room 2”.

The mapping, for example, can be accomplished by developing a layer which interfaces with both of the physical and logical security systems. Both physical and logical security systems can send the coordinates, using the respective communication protocols set forth by the manufacturer of these systems, in the form of action data packets, to the respective interfaces with an event analysis engine described below, wherein a Mapper, also described below, can perform the Mapping process.

Authentication, for example, can be accomplished by integrating a sensor into the asset (e.g., a laptop) to unambiguously authenticate the user. An example of such a sensor is a camera, such as a Webcam, that uses face recognition to ensure that the person using the asset is the authorized user of the asset. Another example of a sensor is a thumb reading slot in the asset that reads the thumb print of a user and that uses fingerprint identification to ensure that the person using the asset is the authorized user of the asset. There may be a degree of redundancy associated with the process—for example, if biometrics are being used, a simpler process would do as well—but keeping in mind the low proliferation of biometric technology compared to passwords/smart cards/other authentication mechanisms, the Mapping process is the best.

Next, based on our analysis to the responses to our India and U.S. VoCs, the following conclusions can be made.

Intruders, who are often employees of the organization, typically use the following mechanisms to steal/reproduce data:
Photocopying important information—such as laboratory notes . . . .
Printing the data and taking the hard copies home . . . .
Video Recording experiments and streaming back home . . . .
Taking important documents using USB drives, CDs, iPods . . . .
Sending important data through personal mail IDs such as xyz@hotmail.com . . . .
   The aforementioned methods are illustrative and not exhaustive.

It is also believed that laptops are stolen for their material value and not for the information contained therein; nevertheless, it is important for companies to ensure that sensitive data is not accessed by unauthorized persons. Hence, it is realized that in order to ensure sanctity and confidentiality of important data [competition sensitive/employee sensitive/customers' data] companies need to ensure that such data is not accessed by anyone except those authorized persons who need to have access to the data in order to carry out their tasks. This protection can be ensured, for example by effecting the following mechanisms:
Data [e.g., source code for programmers, customers data for Customer Service Representatives in banks, etc.] stays within the particular project team/assigned personnel, etc. so unauthorized e-mail forwarding needs to be stopped.
Access to stolen assets should be eliminated . . . laptops and even other physical assets . . . movements need to be tracked . . . their locations need to be known . . . .
If laptops/USB drives/other data carrying devices are realized to be stolen, there must be some mechanism to ensure that the data contained inside is destroyed . . . .
E mails should not be used to forward sensitive/critical data to unauthorized/unintended recipients . . . .
Assets which are physical in nature also need to be prevented from going out [they may contain data in the form of hard copies, for example . . . ] in an unauthorized manner . . . .
   The scope of such mechanisms should not be construed to be limited to the examples described herein.

In summary, it was realized that for every incident where data is compromised, in effect there is some action or series of actions which had gone undetected or, even if detected, the action or actions were not evaluated and responded to appropriately. Of course, there is a person [intruder] who performs the action(s). This conclusion is described below with some examples:

| Incident | Action which went undetected |
|---|---|
| An intruder tailgated, | The intruder's passed through the door |
| found an unlocked com- | without presenting valid credentials |
| puter, and stole some | |
| sensitive data | |
| An employee took a | The photocopying of a sensitive document |
| photocopy of a sensitive | or photocopying in general |
| document and gave it to | |
| an outsider | |
| An employee copied | The process of copying the documents on |
| sensitive data on a USB | the USB drive/plugging the USB drive |
| drive and took the copied | into the laptop! |
| data home | |
| A person forwarding a | The process of forwarding a sensitive |
| sensitive document as an | document to an unauthorized recipient |
| email attachment to a | |
| competitor | |

It is realized that there are some piecemeal solutions available in the market to address some of these incidents but there is no holistic solution which can manage most or all of the incidents in a unified manner. Hence, if a solution can be created that can sense all tangible actions which pose a potential threat to an organization, especially those related to unauthorized access to/reproduction of information, evaluate the actions, as well as respond to those actions which deem a response, then most or all possible incidents where there is the possibility of data loss can be exhaustively prevented.

### BRIEF DESCRIPTION OF THE DRAWINGS

The features and advantages of the arrangements and solutions described herein will become more apparent from the detailed description below when taken in conjunction with the drawings in which:

FIGS. 1A and 1B illustrate a hypothesis sheet useful in developing a questionnaire relating to security;

FIG. 2 illustrates the block diagram of the architecture useful to perform unified threat management;

FIG. 3 illustrates the Overall Process Flow Diagram which explains how unified threat management works;

FIGS. 4A and 4B illustrate the concept of a logical coordinate—what it is and which information asset it identifies;

FIG. 5 illustrates the Action data packet Table, which contains the details of an action being performed on an asset;

FIG. 6 illustrates the Response data packet Tables sent by the action interpreter and detector (AID) and acknowledgement tables sent by the appropriate device in the system space of FIG. 1;

FIG. 7 illustrates the Exception data packet Tables based on pattern recognition, sent by the Pattern Analysis Engine of FIG. 1 if it observes a series of actions which deviate too strongly from normal;

FIG. 8 illustrates the Data packet Tables related to the Mapper component of the event analysis engine of FIG. 1;

FIG. 9 illustrates how changes in a user's physical location results in the Mapper automatically denying access to certain systems;

FIG. 10 is an example of an ID that can be fastened to documents to thereby uniquely identify them;

FIG. 11 illustrates the geography of a hypothetical organization useful in explaining aspects of the present invention;

FIG. 12 illustrates example user arrays stored in the identity database of FIG. 2; and,

FIG. 13 illustrates a computer system that can be used for centralizing the system of FIG. 2.

### DETAILED DESCRIPTION

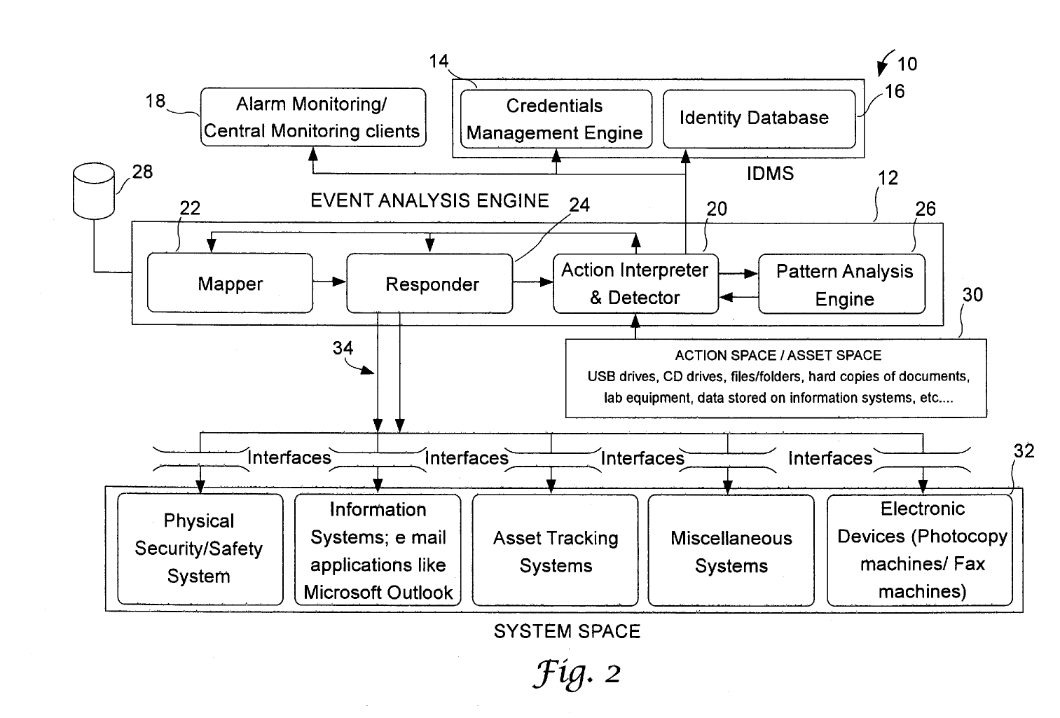

The architecture described herein provides a system 10 as shown in FIG. 2 which senses most or all actions posing threats to an organization, acquires those actions, logs them in chronological order, evaluates them in the context in which they occur, decides if any response is necessitated, and/or carries out the appropriate response, while maintaining a log of the various responses effected. Further, the system 10 logs most or all actions, analyzes the patterns of the actions, and automatically learns what are normal actions in the context of the organization. It can be configured to respond appropriately when a series of events which deviate from the normal/expected happen. The categorization of which tangible actions pose a risk to the organization and which do not could be made, for example, by the Enterprise Risk Management (ERM) team of the organization. Again, this should not be seen in a limiting sense. For a small organization such as a start up company or a cooperative bank, which does not have an Enterprise Risk Management (ERM) team, this categorization can be performed by IT or other personnel, for example. Also, the same context can be extended to homes, buildings, and any entities other that organizations.

The system 10 also provides a tracking and restricted access mechanism to all sensitive “soft assets” such as spreadsheets containing financial data, confidential presentation files, etc., and keeping a track of the number of hard copies of such documents created, the current ownership of these copies, until the time these documents are destroyed/archived.

FIG. 2 is a block diagram of the architecture which describes the components of the system 10. The system 10 includes an event analysis engine 12 which may be hosted by a corresponding server, a credentials management engine 14 and an identity database 16 which also may be hosted by a corresponding server, described herein as an Identity Management Server [IDMS], alarm monitoring client[s] 18, and various connections and interfaces to external systems (e.g., external databases like the HR database).

The event analysis engine 12 consists of four main components—an Action Interpreter and Detector 20, a Mapper 22, a Responder 24, and a pattern analysis engine 26, along with a dedicated memory and database 28.

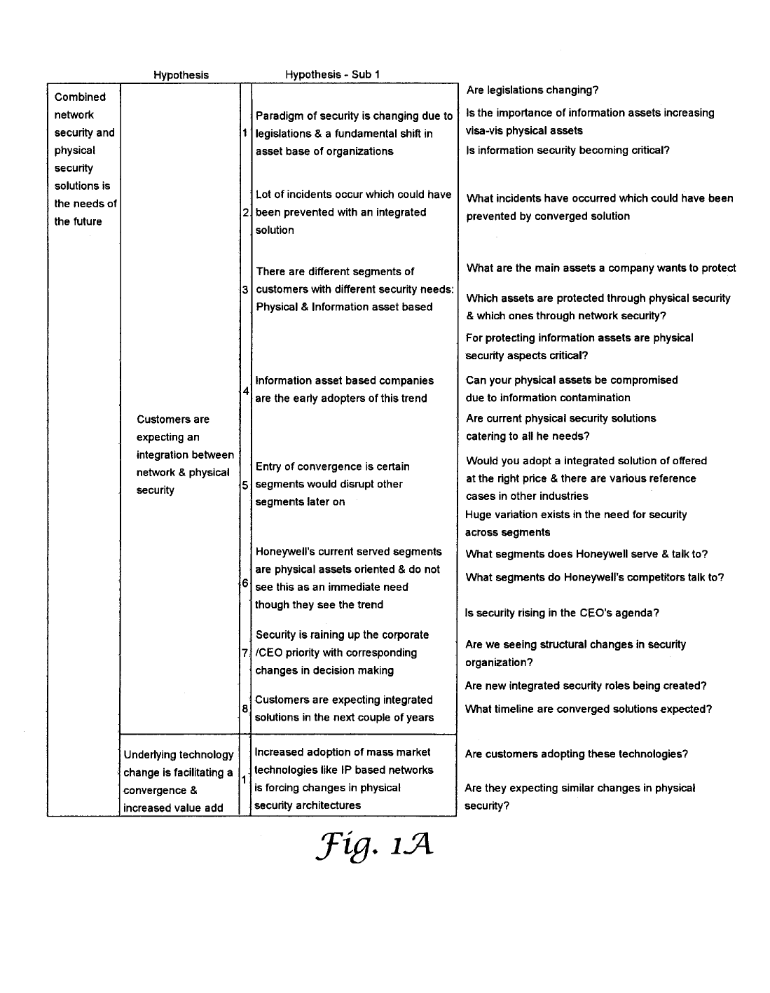

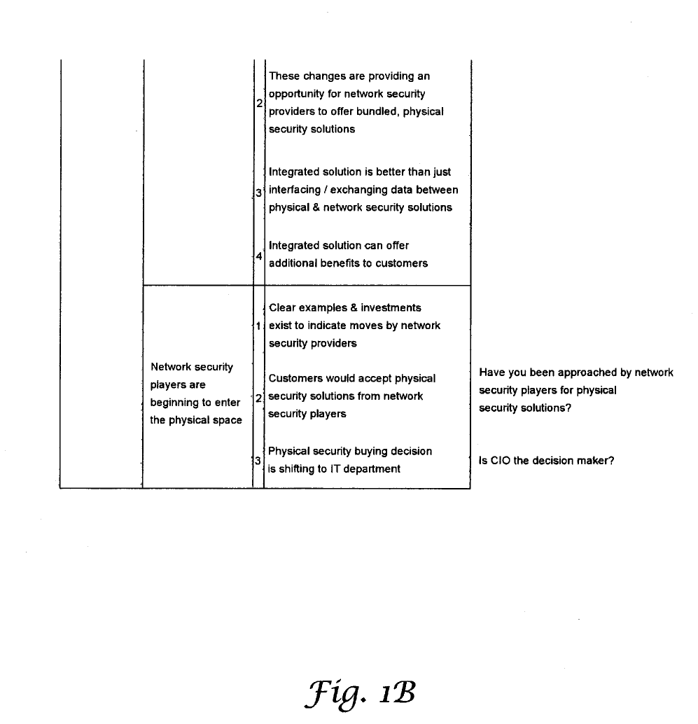

An action space 30 shown in FIG. 1, which may also be referred to as an asset space, represents the threat environment as perceived by the organization. It comprises all the assets which the organization perceives as valuable/critical. The action/asset space 30 includes, for example, data storage devices such as Compact Discs, USB drives, and floppy disks, information processing assets such as desktop computers, laptop computers, and PDA handhelds, physical assets such as laboratory equipment, manufacturing equipment, and maintenance equipment, and enabling infrastructure such as HVAC systems, etc.

FIG. 2 also illustrates a system space 32 which represents all of the various devices and mechanisms that the organization has in place, and that enable the organization to carry out its functions. These devices and mechanisms, for example, include safety and security mechanisms. The system space 32 includes, for example, physical security systems such as access systems, intrusion detection systems, digital video surveillance systems, and fire systems, information systems such as Windows/Unix servers, LDAP servers, and external access protection systems like firewalls and VPNs etc., applications such as e-mail applications, data reproduction devices such as photocopy machines, scanners, printers, fax machines, etc., asset tracking systems [typically including RFID tags coupled with readers used to track the location of assets and their time based movement], and miscellaneous systems [these could include any other systems which the organization perceives could cause potential threats—they can vary from one organization/location/time to another—appropriate sensors/detecting mechanisms could be set up to monitor events in these systems and evaluated]. These examples are illustrative and are not meant to be exhaustive.

The action space and the system space 32 are not necessarily distinct since there are many assets that are intelligent and that can be classified in both spaces. A laptop computer, for example, is a physical asset and hence forms a part of the asset space. It contains mechanisms to authorize a user to access the information contained within or on the organizations' LAN, so it also forms part of the system space. The distinction between these two spaces will become better understood below.

The event analysis engine 12 is connected with a data communications network 34 to the various components of the system space 32. These components of the system space are equipped with sensors and detecting mechanisms [for example—the fire system comprises fire and smoke sensors, information systems have mechanisms to read user credentials such as passwords/biometrics, the digital video surveillance system has IP cameras which can perform video content analysis, etc.] The network of these sensors/detecting mechanisms is referred to herein as the “detector cluster”.

The detector cluster senses all actions [such as a user trying to log on to a laptop, a person moving in a no entry zone, a user swiping his/her access card at the door, a user trying to photocopy a document, etc.] which occur in the action/asset space 30. The detector cluster creates action data packets using this detected action information and sends the packets to the event analysis engine 12 over the network 34. In this way, all tangible actions all “acquired”. The event analysis engine 12 has the dedicated database 28 wherein it chronologically logs all received actions. The event analysis engine 12 evaluates each action considering the context in which it occurs, this context including the other actions which have taken place earlier. Based on this contextual consideration of an action, the event analysis engine 12 evaluates whether a response is necessitated.

The Mapper 22 helps in this evaluation process, in particular, by considering the most common access attempts to physical systems, electronic systems, asset tracking systems and information systems. (The concept could be extended to Miscellaneous systems, as the case may be). If a response is required, the event analysis engine 12 creates action data packets and sends the packets to the appropriate components in the system space 32 over the network 34 to carry out the necessary responses. The command instructions in the action data packets are in accordance with the communication protocol of the Hardware/Software interface of the particular component of the action/asset space 30. Alternatively, if the various components of the system 10 are all IP enabled, the network could be based on the Internet Protocol, which would be the communication protocol throughout. An example from the electronic devices component of the action/asset space 30 is described next.

Honeywell Inc. has a universal software platform that helps manufacturers develop Internet-enabled equipment systems and device-to-enterprise applications, known as the Niagara framework. Various electronic devices are contemplated, such as photocopiers, fax machines, scanning machines, shredders etc., and the intelligent Niagara JACE controller (the Java Application Control Engine controller is the mechanism that provides physical connectivity to a device's network in order to integrate diverse systems). The network enables two way communications between the electronic devices and the intelligent controller (JACE). Based on the communication options available on the devices, the devices may be available on the same network or may have a point to point connection between them and the controller.

The JACE controller runs a software stack called Niagara that abstracts the multitude of devices with which it is communicating. All functionality, such as reading of device information, control logic execution, alarming, event logging, and assembling of custom graphic displays for monitoring, can be performed using this software framework.

Each of the electronic devices may speak a different communication protocol. The JACE controller is capable of communicating with the devices in these different protocols. The JACE controller has device drivers written using the Niagara object model for each of the protocols that it supports. The protocol options available on the JACE controller are extendible—so new electronic devices can be added to the network. The JACE controller is capable of receiving data, typically comprising events that happen on the device from the devices, and is also capable of sending data, typically to command the device. Hence, a JACE controller could be connected to, and can communicate with, photocopy machines, printers, scanners, fax machines, shredders, etc.

The JACE controller is configured such that it knows the identity of each of the devices with which it needs to communicate. The devices and the JACE controller are connected to a physical communication medium (if they are wired connections). A device discovery process is then initiated on the JACE controller to find all existing devices on the communication network. This discovery process uses the device drivers available on the controller to send out a request-to-identify message to connected devices. Devices respond to this request from the JACE controller and the JACE controller lists the devices.

Each of the discovered devices gets its unique identity in the JACE controller. The JACE controller sends information about the addition of new devices to the Identity Database 16. A list of interfaces (or points) for each of the devices is also available in the controller as a result of the discovery process. These points are either input or output points that can be written to or read. Points are used by the controller to read data from the device or to command the device. Actions that take place on any device on the communication network manifest as point values that are read by the JACE controller. The JACE controller is an example of an interface (see FIG. 2) between all the electronic devices and the Action Interpreter and Detector 20. The configurations can vary based on the requirements, locations, and number of electronic devices the organization has. The configuration could have a single site, a single JACE configuration, or a single site multiple JACE configuration. For large organizations, a multiple site multiple JACE configuration may be used.

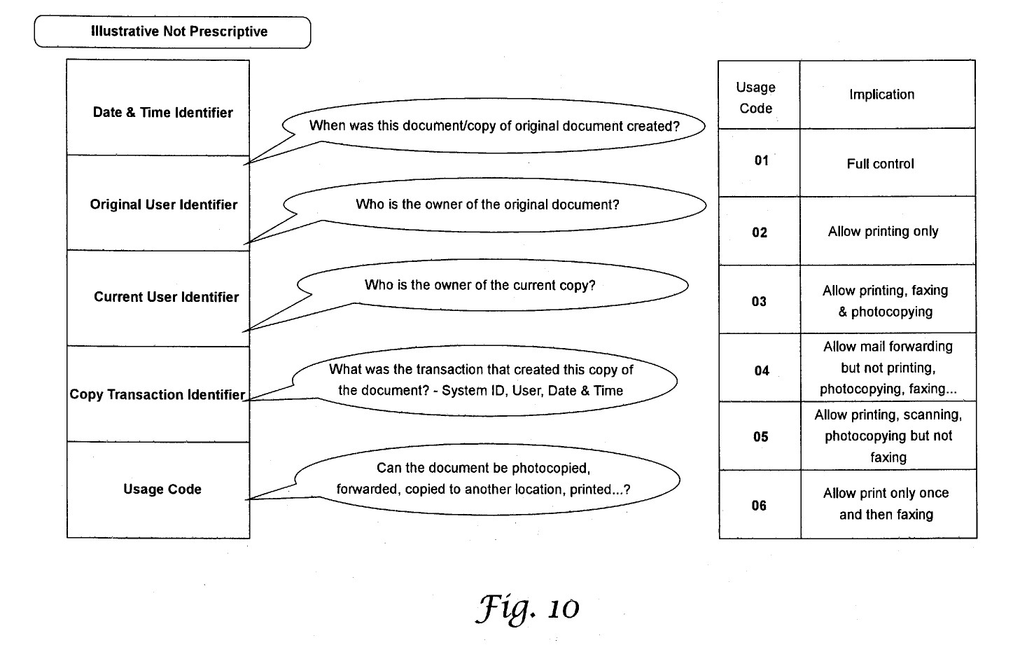

For example, a request to photocopy a document (or a request to fax/scan/shred a document) is an action on the hard copy of a document. The document is the asset in this example. If it is a sensitive document, each page of the document contains a sensitive document ID (SDID; see FIG. 10—the SDID could be a tiny identification mark, similar to a barcode, that contains information needed to identify the document uniquely, as well as the owner thereof) which can be read by other electronic devices, such as photocopy machines, scanners, fax machines, and shredders, when any request is made to these devices regarding processing this document in some manner. All sensitive documents can be printed on a different kind of paper, and whenever this kind of paper is presented to any of the electronic devices for processing, they would not proceed until they read the SDID.

The SDID can be assigned at the time of document creation, perhaps when the document is first printed. The SDID is basically a “hard” version of the logical coordinate, enabling electronic devices to identify the document. Now, each electronic device has a control panel using is used to initiate an action such as photocopying or faxing. When such an action is initiated, a controller receives an action data packet, such as from a document processing device. The action data packet contains details about the action being performed on the asset (in this case, the action is a request to photocopy a document). The action parameters specify the type of action and the data associated with the action.

FIG. 10 illustrates an example of the SDID. The SDID includes a date and time identifier (e.g., indicating when the original of a document was created), an original user identifier (e.g., indicating the owner of the original document), a current user identifier (e.g., indicating the owner of a copy of the document), a copy transaction identifier (e.g., indicating the transaction that created the this copy of the original document), and/or a usage code (indicating permitted uses of the document).

FIG. 10 also illustrates example usage codes where 01 permits full usage of the document, 02 allows only printing of the document, 03 permits only printing, faxing, and photocopying of the document, 04 allows the document to be mail forwarded but does not allow any other uses of the document, 05 permits only printing, scanning, and photocopying of the document but not faxing, 06 allows only one printing followed by faxing of the document, etc. There could be other usage permissions based on company policy. For example, it might be disallowed to send such documents by Chat applications such as Microsoft Office Communicator or through personal mail IDs.

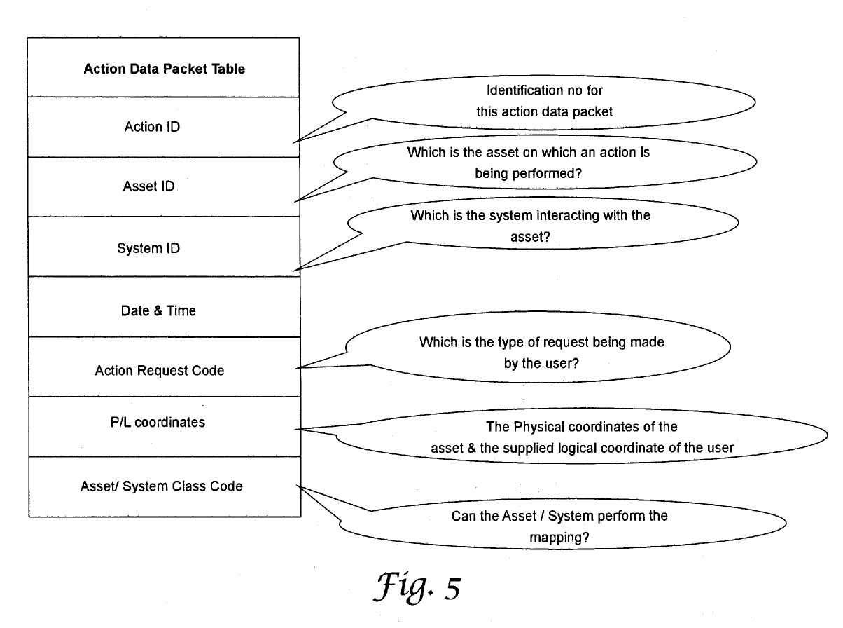

The table of FIG. 5 shows an example of the structure of the action data packet. The action data packet includes an action ID indicating the number of the action data packet, an asset ID indicating the assets on which the action is being performed—in this case, it would be the SDID of the document (if we were talking about an action of access to an information asset such as a laptop—then the laptop becomes the asset, the asset ID is same as the system ID), a system ID indicating the system in the system space 32 that is interacting with the asset (in this case it is the photocopy machine), the date and time of the action, an action request code indicating the kind of process that the user has requested to be performed (a photocopy machine, invariably, could be used for one purpose, i.e., photocopying, while some other devices could be requested to perform several actions; for example, a central controller must know the type of action[s] amongst the various possible processes the user is trying to perform), the physical coordinates of the asset and the logical coordinates of the user who is attempting to use the asset, and/or an asset/system class code indicating whether the asset or system can perform a local mapping.

The JACE controller collects all this information from the device, creates the action data packet table, and sends it to the Action Interpreter and Detector 20.

Now, the Action Interpreter and Detector 20 sends an acknowledgement for the receipt of the action data packet. In case an acknowledgement is not received, the JACE controller records an error. In this case, the JACE controller would disallow the request, e.g., photocopying, or would execution of the request with some conditions attached.

Once the Action Interpreter and Detector 20 has received the action data packet, it has the information that it needs to be able to make the decision. The Action Interpreter and Detector 20 can call up the logical coordinate for the asset/system interacting with the asset [the password required to access that asset from the Identity Database 16—the password for the soft copy of the document in this case will do—it would have also have previously received the physical coordinate of the user when the user has accessed the particular area of the facility where the photocopy machine is located]. Now, if the asset is intelligent enough, it can do the mapping of coordinates itself. In this example, the document cannot do that. If the system which is interacting with the asset is intelligent enough, it can do the mapping of coordinates for the asset. The Asset/System Class Code in the action data packet table is True if either the Asset or the System interacting with the Asset can carry out the mapping or False if both cannot perform mapping, and is available to the Action Interpreter and Detector 20.

Now, in this example, if the photocopy machine has a Mapping capability, the Asset/System Class Code in the action data packet would be true. In this case, all that the Action Interpreter and Detector 20 will do is log the received action in its database for the purpose of record and pattern analysis, and send a command data packet which includes the rest of the information needed by the Photocopy machine to perform the mapping. This information might include, for example, the physical coordinate of the user as per the records of the event analysis engine 12 as well as the user trust rating as per the records of the Identity Database 16. With this information, the Photocopy machine now performs the mapping and, based on whether the mapping is true or false, it would grant or deny access, respectively. In this case, assuming that the physical coordinates match, if the trust rating of the user is greater/lesser than or equal to the minimum trust rating for the document, the requested action would be permitted/disallowed.

The photocopy machine would then send an acknowledgement packet, which would also inform the Action Interpreter and Detector 20 about whether the command was executed successfully or not and if it was executed after some delay. In case the command could not be executed, the Action Interpreter and Detector 20 logs the same in a failed commands log within the event analysis engine 12 for later review. It may also send an alarm, depending on the configuration, to one or more of the alarm monitoring clients 18.

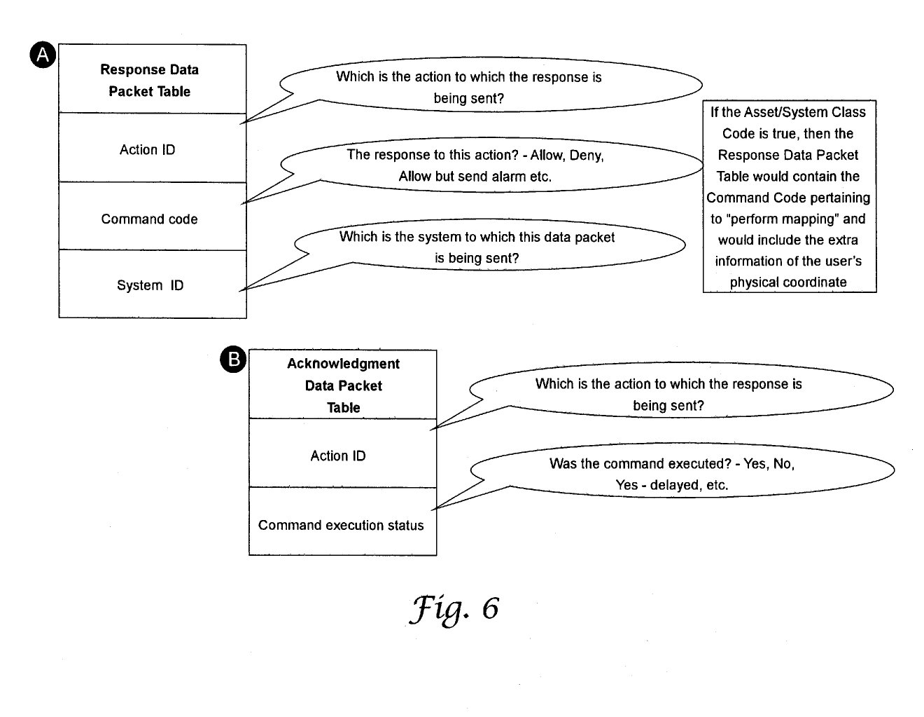

In the case where the photocopy machine does not have a Mapping capability, the Asset/System Class Code entry would be false. In this case, the Action Interpreter and Detector 20 will perform the Mapping itself. Based on whether the mapping result is True or False, the Action Interpreter and Detector 20 would generate a suitable command for the photocopy machine. The command would be sent in a response data packet (see FIG. 6) to the photocopy machine, which would attempt to execute the command, and send another acknowledgement packet expressing the results of the attempt. In case the command could not be executed, the Action Interpreter and Detector 20 logs the same in the failed command log within the event analysis engine for later review. The Action Interpreter and Detector 20 may also send an alarm, depending on the configuration, to one or more of the alarm monitoring clients 18.

In both the cases, the Action Interpreter and Detector 20 logs the actions. The pattern analysis engine 26, which is a software code based on statistical analysis/genetic algorithms/neural networks, observes the pattern of the actions, and may intervene if the observed pattern deviates too strongly from norm. For example, if the concerned user has just photocopied four sensitive documents, and is attempting to copy a fifth one, the pattern analysis engine 26 may decide that this pattern of photocopying is too far from the norm. Based on this decision, the pattern analysis engine 26 itself may send a response data packet (see FIG. 6) instructing the photocopy machine to deny copying.

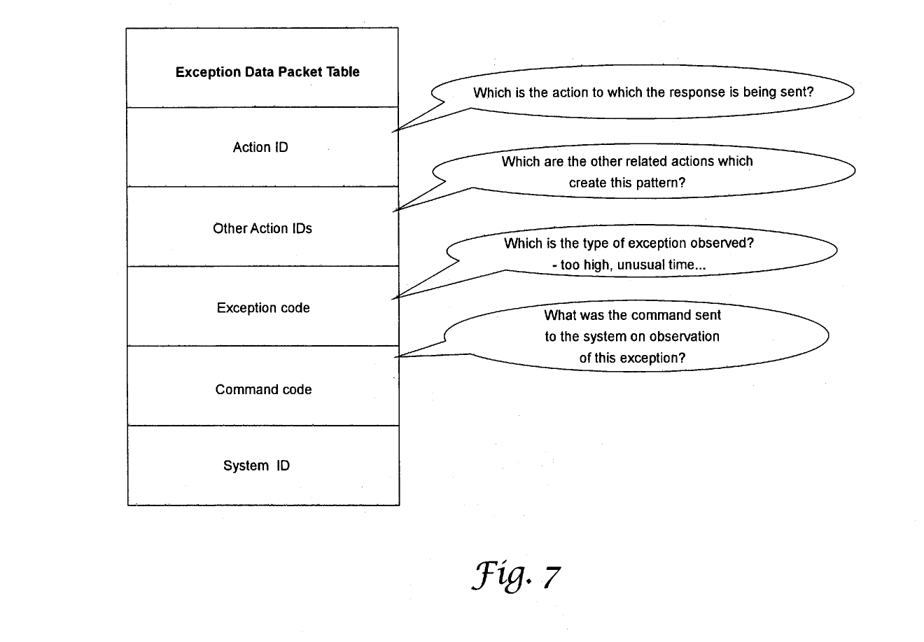

The response data packet table of FIG. 6 shows an example of the structure of the response data packet. The response data packet includes an action ID indicating the action causing the response to be sent, a command code indicating the particular response to be implemented, and/or a system ID indicating the system to which the response data packet is being sent. The response data packet sent by the pattern analysis engine 26 is similar to those sent by the Action Interpreter and Detector 20. The pattern analysis engine 26 sends exception data packets to the AID, for the record. The exception data packet table of FIG. 7 shows an example of the structure of the exception data packet. The exception data packet includes an action ID indicating the action causing the response to be sent, other action IDs indicating the other related actions creating the pattern, an exception code indicating the type of exception that is being observed, a command code indicating the particular exception that is being observed, and/or a system ID indicating the system to which the response data packet is being sent.

However, the commands given by the pattern analysis engine 26 take precedence over those sent by the Action Interpreter and Detector 20. So, if the Action Interpreter and Detector 20 has sent a command to grant access while the pattern analysis engine 26 instructs otherwise, the command from the pattern analysis engine 26 would be executed. The commands sent by the pattern analysis engine 26 are given priority over all other commands in the queue—for delivery to the appropriate system—on all interfaces of the system. In the case the command of the Action Interpreter and Detector 20 was executed before the command of the pattern analysis engine 26 was received, the acknowledgment data packet (see FIG. 6) to the pattern analysis engine 26 would take precedence and alarms would be generated and sent to one or more of the alarm monitoring clients 18, and the Action Interpreter and Detector 20 would revoke the access privileges of this user till a suitable manual intervention is made. This suspension of privileges would be Mapped on to the Identity Database 16.

The acknowledgement data packet table of FIG. 6 shows an example of the structure of the acknowledgement data packet. The acknowledgement data packet includes an action ID indicating the action corresponding to the response, and/or a command execution status indicating the execution status of the command.

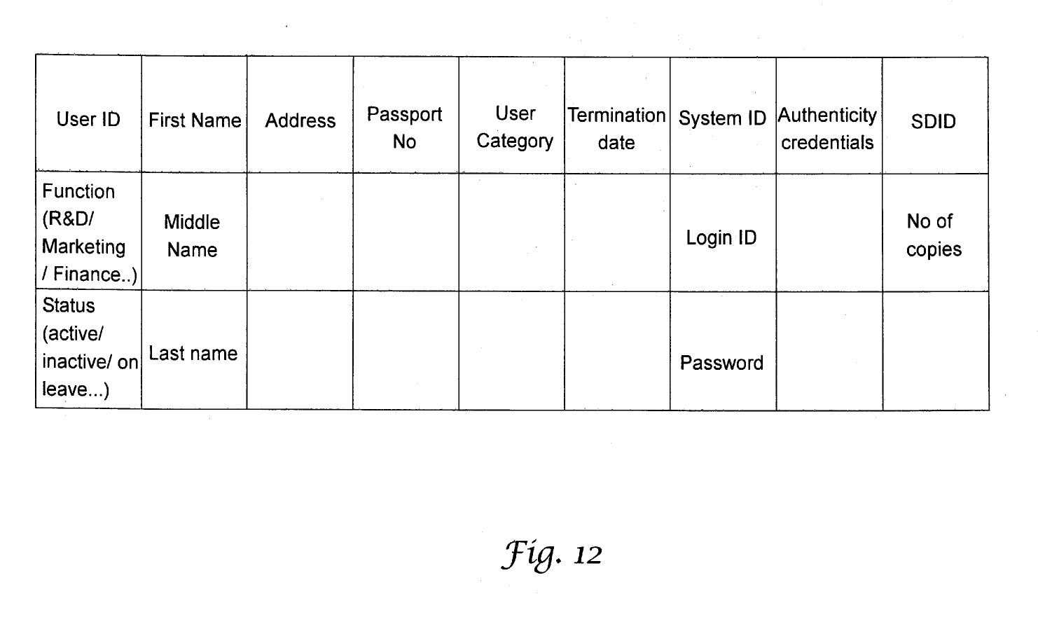

The following table illustrates how the pattern analysis engine 26 can address some possible incidents. In most cases, it could be a genuine user trying to execute his task—the response would not be as extreme as suspending access privileges—it could be just a mailer to an appropriate authority identifying the abnormal behavior—such monitoring discourages intentional unauthorized action.

| Incident | How the pattern analysis engine 26 reacts |
|---|---|
| A group of video | It could be a coordinated attack - possibly |
| cameras suddenly | an attempt to allow a few intruders by |
| go still or start | tailgating inside - the pattern analysis |
| staring into | engine 26 realizes that while one video |
| irrelevant space | camera pointing at irrelevant space could |
| [where there | be acceptable, but several cameras pointing |
| exists no reason | at irrelevant space is a far from normal |
| to monitor] | event and flags appropriate alarms & |
| | commands |
| An employee comes | The pattern analysis engine 26 realizes |
| to office on | that Sunday is not a normal working day and |
| Sunday and starts | copying disproportionately large amount of |
| copying a lot of | data on Sunday is not normal - it flags |
| data on USB | appropriate alarms & commands |
| drive/his laptop | |
| from the network | |
| An employee who | If the user's department/area of work has |
| normally accesses | changed, such change would reflect in the |
| Buildings A & B | User Arrays [FIG. 12] - if it is not |
| suddenly accessed | reflected, even then it is possible that |
| Building C 10 | the user might have genuine work. |
| times on a day | Nevertheless, having observed the abnormal |
| | series of actions, the pattern analysis |
| | engine 26 would send a self generated mail |
| | to the appropriate authority |

The Event Analysis Engine 12 could also be configured to take certain actions based on Business Policies. For example, an attempt to photocopy a sensitive document after office hours may result in alarms being generated and sent to one or more of the alarm monitoring clients 18. The fact that the Action Interpreter and Detector 20 evaluates actions considering the context in which they occur and that the pattern analysis engine 26 differentiates normal series of actions from abnormal ones allows context based decisions to be made in real time. At the same time, decisions could also be taken based on Business Policies as discussed above, such as where an employee whose termination date has arrived would have all his access privileges automatically revoked and hence would not be able to photocopy the document.

The event analysis engine 12 has been described as a central Event analysis engine thus far. However, the JACE controller can itself be programmed with control logic that is automatically executed when configured point values change. The control logic can be reprogrammed at any time using the JACE configuration tool (called the workbench). The JACE controller can then decipher the action data using the device driver associated with a device and run its control logic. The control logic can also be programmed such that it can verify the identity of the user and the credentials of the user from the respective engines. The control logic can then determine whether the requested action is allowed or disallowed. If the action is not allowed, then the control logic on the JACE controller commands the device so that the action is stalled on the device. For example, the JACE controller can write to the relevant point on the device and this write stalls the action on the device.

The JACE controller can also be configured to raise alarms, and log event data. If the JACE controller is thus configured, the alarms it raises will be available for viewing by one or more of the alarm monitoring clients 18. All alarm and event logs are persisted on the JACE controller and can be viewed at any point of time. Hence, the JACE controller can be made to function as a decentralized action interpreter and detector, with a capability to also perform Mapping. This architecture could help monitor a number of devices depending on the capacity of the JACE controller. In a large organization where several actions are being performed every moment, the traffic on the centralized Event Analysis Engine 12 could be enormous. Hence, such decentralization may be important in order to handle all actions smoothly.

In fact, it may be desired to incorporate a decentralized action interpreter and detector and Mapper on all data processing devices, such as laptop/desktop computers and PDA handhelds, so as to take several of these decisions locally.

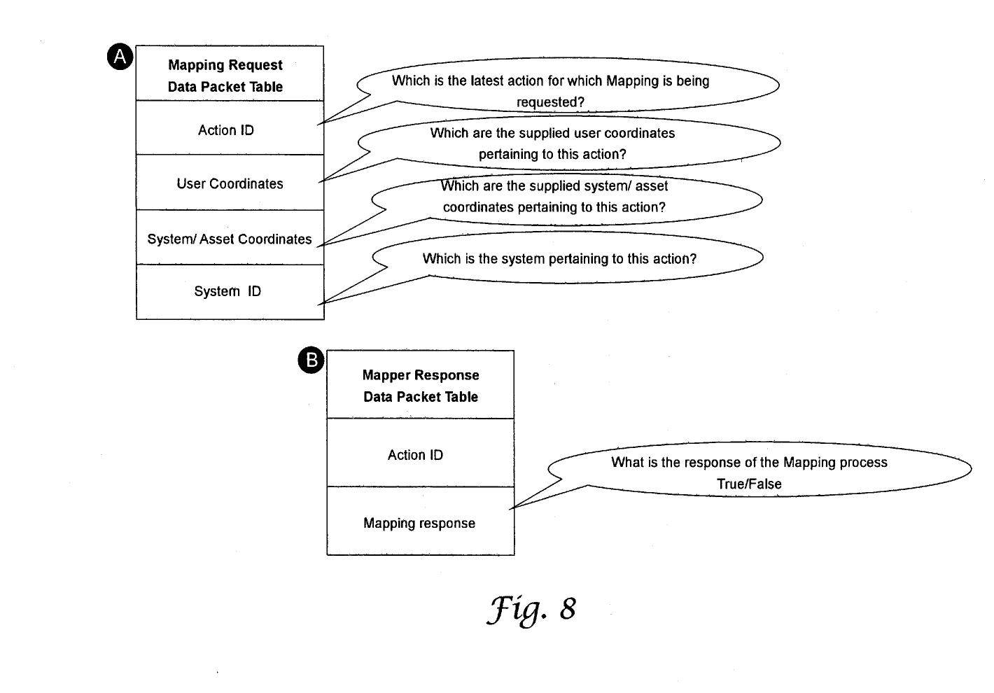

The communication between the centralized and decentralized action interpreter and detectors and their respective Mappers is explained in connection with FIG. 8. All relevant coordinates are sent to the Mapper, which Maps the relevant coordinates and replies either True or False. The Mapper identifies the request using the Action ID, which is the latest action for which the Mapping is being requested. As the detector cluster keeps acquiring the Physical coordinates of the users it keeps sending them to the Mapper.

The mapping request data packet table of FIG. 8 shows an example of the structure of the mapping request data packet. The mapping request data packet includes an action ID indicating the latest action to which mapping is being requested, user coordinates indicating the coordinates of the user pertaining to the action, system/asset coordinates indicating coordinates of the system and/or asset pertaining to the action, and a system ID indicating the system corresponding to the action.

FIG. 8 further has a mapper response data packet table illustrating an example of a mapper response data packet sent by the mapper 22. The mapper response data packet includes an action ID indicating the latest action in response to which Mapping was performed being processing by the mapper 22, and/or a mapping response indicating the response of the mapping process.

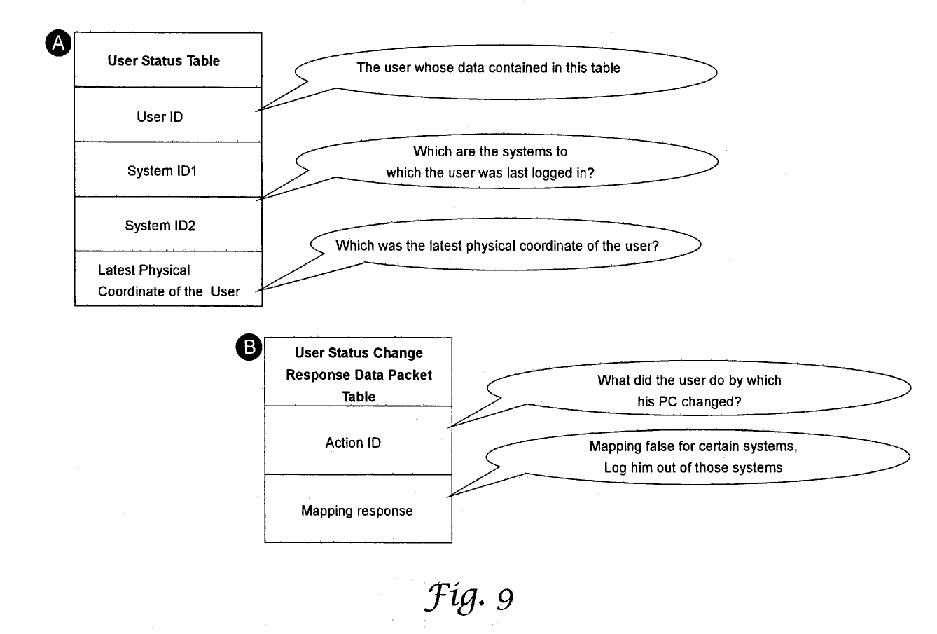

The Mapper 22 has a table for every user and also a record of the last “True” Mapping results for every user as shown in FIG. 9. If the user moves out of a room and swipes his access card on his way out, it is important to log him off those machines. The Mapper sends automated updates to the action interpreter and detector, citing the Action ID (of the user going out), and the action interpreter and detector 20 sends a log out user command to the respective systems.

The user status table of FIG. 9 includes a user ID indicating the user whose data is contained in this table, first and second system ID indicating the systems into which the user was last logged (there could be more systems—a person working in a certain area might be working on two computers, be logged on to a photocopy machine, etc.), and/or the latest physical coordinate of the user.

FIG. 9 further has a user status change response data packet table illustrating an example of a user status change response that is sent by the event analysis engine 12 to appropriate systems whenever the status of the user changes. The user status change response data packet includes an action ID indicating what the user did to result in the user's change in status, and/or a mapping response indicating an appropriate response to this action.

Thus, for every tangible action on an asset, the detector cluster in the asset space senses the action, acquires the same to be sent to the centralized or decentralized action interpreter and detector which will ensure that Mapping is performed and accordingly grant or revoke decisions are made.

The Mapper 22 ensures that only the genuine user is granted access to an asset such as a computer. For example, the mapper 22 ensures that only the user who has physically entered that particular part of the facility where the asset is located (it could be in the person's home) or brought inside in a genuine manner is allowed to gain access to the network resource present there. The identity of the user also needs to be verified continuously.

The Mapper 22 is a software agent which correlates the physical and logical coordinates of the user with the physical and logical coordinates of the information system which requires user authorization whenever an event occurs. Unique physical and logical coordinates are assigned to each asset or terminal (laptop, desktop, PDA, etc.) in all of the organization's facilities. If a unique logical coordinate could be assigned to all computers globally in the future, that is best. As an example, currently a Globally Unique Identifier or GUID (a pseudo-random number) is produced by the Windows OS or by some Windows applications. Windows identifies user accounts by a username (computer/domain and username) and assigns it a GUID. While each generated GUID is not guaranteed to be unique, the total number of unique keys is so large that the probability of the same number being generated twice is very small.

A logical coordinate, which is unique and non super imposable (the coordinate on one object in the logical space is like the fingerprint of a human being: it cannot be assigned to another object in the logical space) is also used as discussed herein. Since GUID can also be used to identify applications, files, database entries, etc., any restricted network assets (such as shared resources to which only a few employees need to have access or confidential customer data) can also be provided with GUIDs, and the Mapper 22 would again map the coordinates of the person trying to access such files to grant/revoke access. Thus, it can again be verified that only the genuine user can access the restricted files. Of course, a logical coordinate that is more accurate (and absolutely unique) than the GUID can be used. Only sensitive documents need be assigned a logical coordinate—to optimize usage and avoid network congestion due to innumerable decision making process.

The mapper 22 understands the geography of the organization: the locations of computers, servers in rooms and how those rooms can be accessed. Whenever an attempt to log on to a network asset is made, the Mapper 22 retrieves the physical coordinate of the user (maybe in real time, in which case the mapper 22 already has the physical coordinate in advance], the mapper 22 checks whether the physical coordinate of the user matches the physical coordinate of the network asset being accessed by the user (thus ensuring that the asset is present where it is supposed to be), and the mapper 22 also checks whether the logical coordinate of the user matches that of the network asset. If the coordinates match, the mapper 22 grants access to the user.

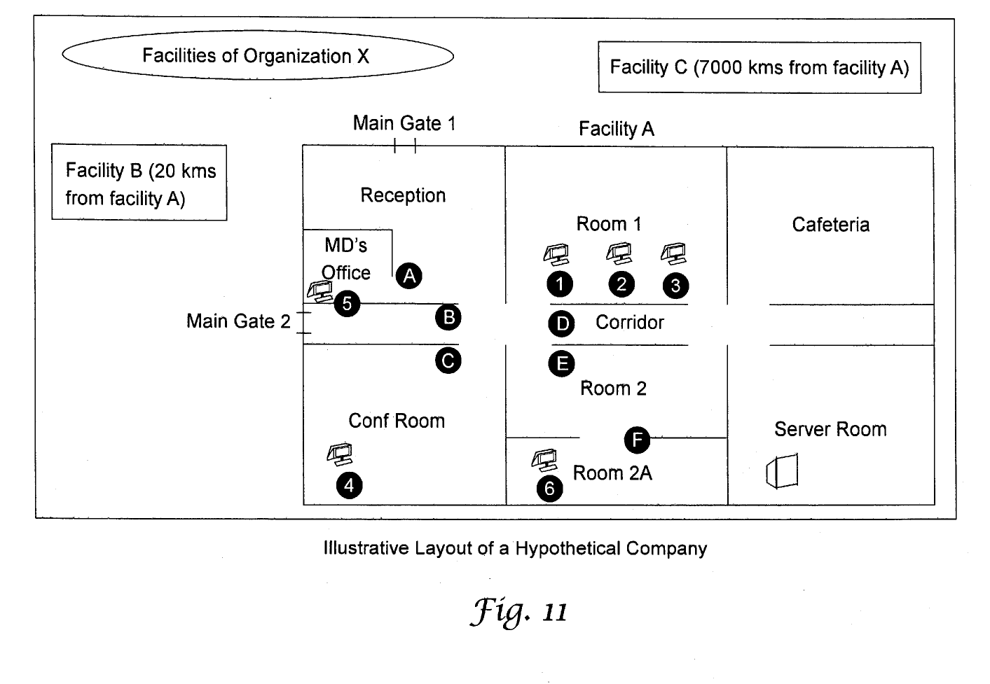

The following examples with reference to FIG. 11 explain the working of the Mapper:

1. Geographic check: The Mapper 22 understands that Room 2A comes after Room 2 such that one can only enter 2A after having entered through Room 2. This geography means that the genuine user of logical coordinate 6 (such as a networked desktop computer or a network port where the user can plug in his laptop) needs to swipe his access card on Main Gate 1 [if applicable] followed by door B followed by door E followed by door F. Alternatively, the user could swipe his access card on Main Gate 2 [if applicable] followed by door E followed by door F. If the user does not swipe his card in this manner, the Mapper 22 evaluates non matching physical coordinates and revokes access. Of course, a swipe at door f would result in an access grant only if door e has been accessed earlier, by the same token.

2. Timeline check: Facility A is 20 kms from facility B. If a person leaves facility A at 5 PM (he swipes his access card as he exits one of the doors or at the main gate [if applicable] and then tries to gain remote access to a resource within facility A from facility B at 5 minutes past 5 PM, the Mapper 22 at facility A considers the fact that an employee who left 5 minutes back cannot possibly be logging in through facility B and revokes access.

3. Duplication check: If a user is present at facility A working in his cubicle and a remote login attempt is made at the network using this user's credentials, the Mapper 22 again considers that since the user is present within the facility [his logical coordinate: the password is in use], he could not be possibly logging in from outside the facility. The Mapper 22 may prompt the user working within the facility for the logical coordinate again (to ensure that it is he who is working) and if it is so, the mapper 22 revokes access for the remote attempt.

Also, if facility C is in another country, one cannot simultaneously gain physical access to both facilities A and C. If an employee of facility A travels to facility C on official work and swipes his card at facility C, and during his absence another employee tries to gain access to the employee's desktop/shared network resource using the latter's password, the Mapper 22 again observes the discrepancy and revokes access. Alternatively, the mapper 22 can be configured in such a manner that, as long as “Out of office Auto reply” is activated by a user, all his resources are blocked except for his own remote login till he comes back and deactivates the Auto reply.

The Action Interpreter and Detector 20 is a software engine through which all tangible actions which possess a potential of posing threat to the organization, whether in the physical or the logical space, are routed, and which makes a decision regarding a suitable response to each of those events after taking into account the context in which the action has occurred and analyzing it in an exhaustive manner. The Action Interpreter and Detector 20 supports other applications such as policy execution and threat modeling.

Whenever any action which has the potential of causing a threat to the organization occurs, it is routed through the Action Interpreter and Detector 20, which makes a suitable decision about how the action should be handled considering the context in which it occurs. As an example, all of the following actions possess the potential to cause a threat to the organization:

| Action | How it is a potential threat |
|---|---|
| Somebody breaking a glass | It could be an attempt to gain |
| pane | unauthorized access to workplace |
| | to steal data/physical assets |
| Fire | It could destroy physical assets |
| | and information |
| Somebody presenting his | Important to know who entered |
| access card at the door | which building and when: else |
| | unauthorized persons can gain |
| | entry |
| Somebody trying to | It could be an unauthorized |
| photocopy a document | attempt to steal a sensitive |
| | document |
| Somebody presenting his | Important to know who logged on |
| login credentials to log | to the network and when: else |
| on to the network via VPN | unauthorized persons can gain |
| | access |

Hence, all of these actions have to be dealt with, without exception, to minimize overall risk to the organization.

In order to ensure that the right decision is made, the Action Interpreter and Detector 20 needs to understand the context. Hence the Action Interpreter and Detector 20 interfaces with the Identity database 16 and the credentials management engine 14 for this purpose. The Identity database 16 and the credentials management engine 14 supply the information to the Action Interpreter and Detector 20 about the identity and privileges of the users (employees, contractors, vendors, etc.) and the Action Interpreter and Detector 20 uses this information to make its decision. For example, if a user presents his access card at the server room door and the Action Interpreter and Detector 20 through interfacing with the Identity database 16 and the credentials management engine 14 determines that this user is a contractor who does not possess the authority to enter the server room, the Action Interpreter and Detector 20 would revoke access for this user (and probably send an alarm to one or more of the alarm monitoring clients 18). In conclusion, the Action Interpreter and Detector 20 monitors and deals with all the threats in the event space.

Further, the Action Interpreter and Detector 20 is a self learning unit. Based on observing several events and analyzing them, it begins to understand what is normal in a particular scenario and what is not. The Action Interpreter and Detector 20 performs a statistical analysis of the pattern of events observed in the security domain until a probabilistic estimate of what is likely to happen is arrived at. For example, if an employee accesses a certain door inwards and outwards about five times a day for two months, the Action Interpreter and Detector 20 begins to understand that the nature of this employee's work is such that he needs to go in and out probably five to ten times a day. If on a particular day, the same process is observed for say the fifteenth occasion, an “unusual observation” alarm could be sent to security personnel and on the twenty-fifth occasion the access card could be revoked. When the “unusual observation” alarm is generated, it may not be a serious issue. Hence, the security personnel might not need to go to the user's workplace to verify. But the Action Interpreter and Detector 20 can be configured to take some action such as classify this alarm as “respond by turning cameras to the user's workplace,” etc. Hence the Action Interpreter and Detector 20 is an intelligent and proactive unit.

Predefined timelines based events: If a user's badge is valid for a certain period, on the expiry of that period (this data is stored in the user array in the Identity Database 16→which sends a User Expiry message data packet to the AID 20), assuming that the same has not been extended, the Action Interpreter and Detector 20 automatically sends instructions to all the systems (access, intrusion, information systems, etc.) affected by the user to block his access.

Continuous user identification and self generation of events: It is proposed that the user be identified, wherever practical and feasible, continuously using either webcams or RFID tags on the person of the user (such as integrated with the user's access cards). Whenever the user moves away from the computer, the Action Interpreter and Detector 20 can sense this movement through a bitmap change in successive frames observed by the webcam or through change in RF readings and can generate a command for the computer to lock itself. Depending on level of security, this feature can be turned on or off.

Identity Management Server [IDMS]—The Identity Database 16 keeps a record of all users and the access privileges to various assets and areas of facilities that they possess. Associated with each user is a user table [FIG. 12]. The user table is an array of user's personal data [including name, address, information like passport number, blood group, social security number—the details could be expanded to include all information that is relevant to the organization's functioning—airlines frequent flier no, PAN no etc.], details of the various information systems that the user has access to, being identified by their System IDs and the user's Login ID & Password—if the mechanism of authentication is different from password, the electronic format of the alternative identification mechanism would be stored here. It also contains details of all the hard copies of sensitive documents that the user possesses. Whenever the user creates a copy of a sensitive document, the number against the corresponding SDID increases by 1 and whenever s/he shreds a copy this number decreases by 1. Hence, a record of the no of copies of sensitive documents possessed by various users in the organization is kept in the Identity Database. Querying commands can be sent by one or more of the alarm monitoring clients to the Identity database to retrieve such information, based on User ID, Document ID, by specifying the dates when accessed, etc. The user array is extendible—and if the user gets access to more information systems or achieves possession of more sensitive documents, appropriate no of columns can be added to the array to register the entries. In summary, the Identity Database contains tables of all authenticity credentials of all users.

The Credentials Management Engine 14 contains tables which define various privileges based on categories of users—permanent employee, temporary employee, trainee, contractor, worker, etc. Whenever a new user is added in the external database such as the HR database, the Identity Database reads this action & creates a new user array. It then checks with the Credentials management engine and determines, based on the category of the user, the privileges of the user—for information systems, physical security/safety systems, electronic devices and miscellaneous systems. These default privileges, as determined by the Identity Database, are sent by mail, to an authorized recipient such as the new user's supervisor or the IS personnel. If the supervisor feels that enhanced/reduced privileges are required, s/he can make a request to the appropriate department [facilities management/IS/Materials . . . ]. An operator from the Central Monitoring clients can then effect a change in the user's privileges by issuing an appropriate command to the Identity Database. Consider, for example, if a new user is added, the Identity Database looks up the privilege tables in the Credentials Management Engine and determines the default privileges of the user for various information systems. It creates a new user table, using the details available in the HR database and adds columns for all the System IDs of all the information systems to which the user has access. It automatically determines a Log in ID/password for each such information system and adds it to the record. It then sends commands to each of those information systems with all required information to open a user account with these default credentials. As the new account is opened, the user is mandated to change his/her password which is then updated in the Identity Database.

The following illustrates with several examples the operation of the system 10.

### EXAMPLE SET 1

### Controlling the Flow of Sensitive Information

Suppose the Head of Strategy creates and sends out the annual Strategic Plan of the company and further suppose that the Strategic Plan discloses the acquisitions the company is going to make, the areas which the company considers to be non core, the outsourcing plans of the company, etc. In other words, the contents of this Strategic Plan are highly sensitive and must be prevented from reaching anyone except those employees who are authorized to view this information.

Therefore, the local event analysis engine 12 on the desktop computer, laptop computer, PDA handheld, or any other device which is being used to forward this Strategic Plan must prevent unauthorized access. At the time of creating the Strategic Plan document. & saving it for the first time, the event analysis engine 12 causes a question box to pop up. The question box has some very simple questions including, for example, the following:

Is the information Customer Sensitive?

Is the information Competition Sensitive?

Is the information Internal Employee Sensitive?

In this case, the information is primarily competition sensitive because the competition would definitely be interested to know the organization's strategies. The information is also internal employee sensitive because the employees value their jobs. Hence, leakage of this information to any person other than those designated could create havoc.

The answers to the questions in the questions box could be simple yes or no or maybe answers, or the answers may be in the form of a choice box in which the sender places values in answer to each of the questions (e.g., Competition Sensitivity may be ranked four on a five point scale). The intent should be to cut down the time of answering the questions to a few seconds while capturing the maximum information. For non sensitive documents, there might be a “dismiss” option in the question box when they are first created.

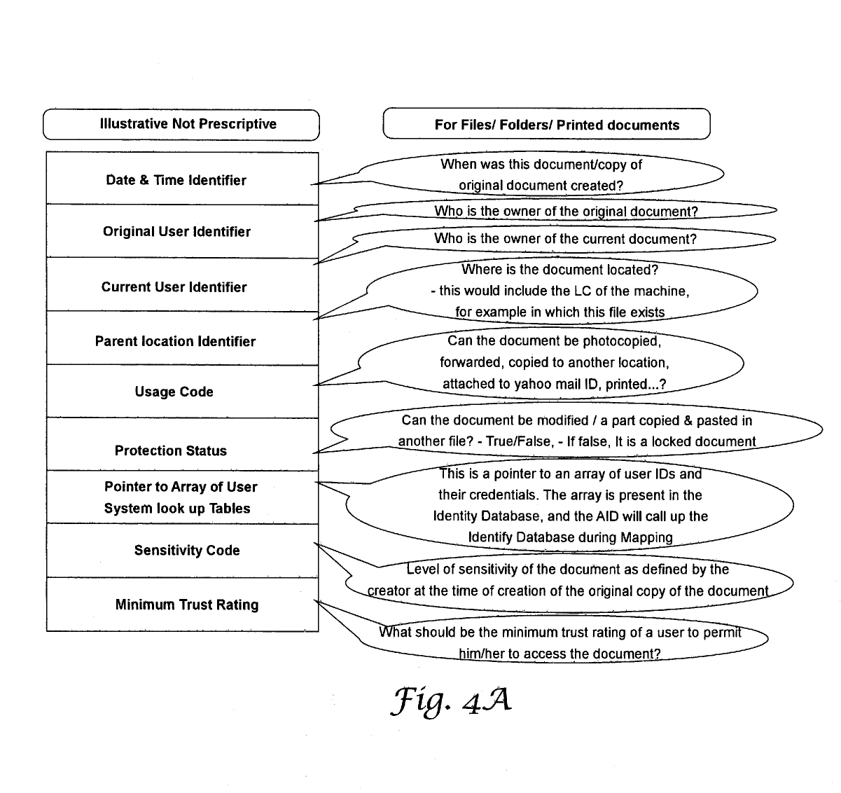

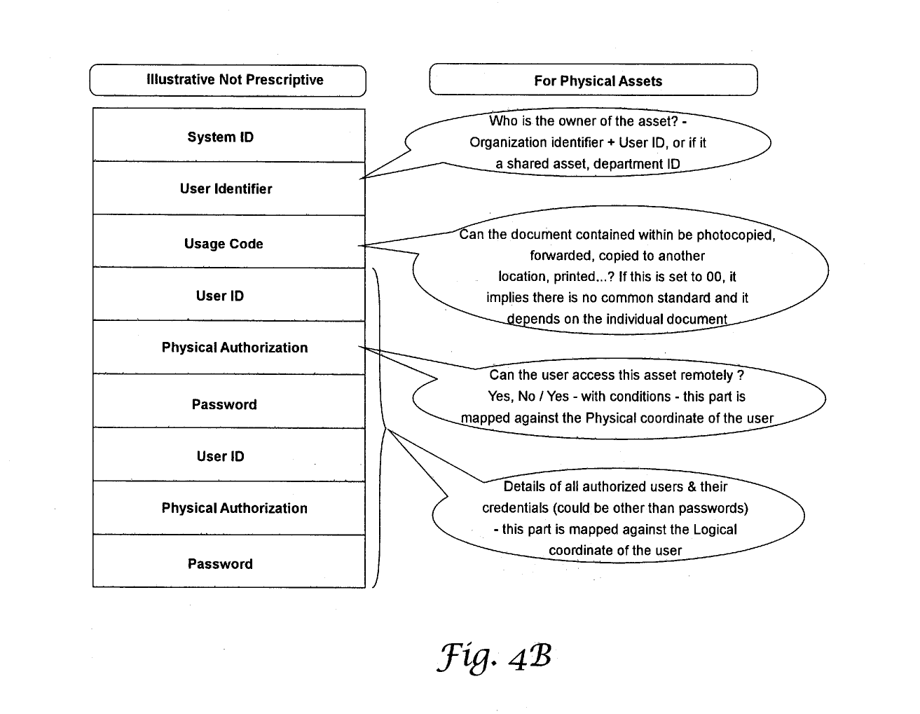

Let it be assumed that the software of the event analysis engine 12 assigns a total rating of nine out of ten in this case based on the user inputs, and that this rating implies “highly sensitive”. Having thus classified the asset as highly sensitive, the software of the event analysis engine 12 now places a tag on this asset thus monitoring the recipients of this asset, the number of copies of this asset which are created further, etc. At the time of creating this asset (i.e., the Strategic Plan), the creator could be prompted to answer additional questions such as whether printing and faxing are to be allowed to which the creator might yes or no or yes with certain clauses. These answers form a part of the Logical Coordinate of this asset, as described in FIG. 4A.

As shown by way of example in FIG. 4A, a logical coordinate may include a date and time identifier (e.g., indicating when a document was created), an original user identifier (e.g., indicating the owner of the document), a current user identifier (e.g., indicating the current user of the document), a parent location identifier (e.g., indicating the original location of the document), a usage identifier (e.g., indicating the allowable use of the document), a protection status (e.g., indicating how the document is to be protected), and/or a pointer to an array (such as a look up table) of user IDs and their corresponding credentials. (When physical assets such as laptops, USB drives, PDA handhelds, etc., are referred to, the logical coordinate would only identify the System ID, the user identifiers, and the details of authorized users and their passwords/other authenticating mechanisms—it is the latter which is mapped against the credentials.

Now, if one of the recipients of this document by e-mail chooses to forward this mail to an unauthorized recipient—such as an outsider (based on company policy, this forwarding could be forbidden, or could be permitted with the option of audit trail), the local event analysis engine 12 would sense or acquire this event and send it to the centralized Action Interpreter and Detector 20. The centralized Action Interpreter and Detector 20 would make appropriate decisions based on the company's security policy. The Action Interpreter and Detector 20 could send an alarm to one or more of the alarm monitoring clients 18, an automated alert e-mail to the originator of the document, etc. In case the originator has set a “Do not print” condition on this asset, and a recipient tries to print this document, this action is again sensed and acquired and the local Action Interpreter and Detector 20 denies printing.

A dynamic trust rating can be assigned to each person in an organization, based on designation, information flow control etiquette, etc. For example, a senior executive with a clean background and a good track record of not sharing sensitive documents could be assigned a high trust rating of nine out of ten. On the other hand, a middle level executive with a track record of printing and losing several documents, and/or forwarding sensitive documents to unauthorized recipients might be assigned a low trust rating of three out of ten. This trust rating of users changes as per their actions, their position, and their roles in the organization—this rating is stored in the Identity Database 16 to be accessed by the Action Interpreter and Detector 20 when required. The trust rating is the primary parameter which is considered during the process of mapping of logical coordinates.

In cases where the originator has allowed printing, it is still important to prevent indiscriminate proliferation of the document. Hence, it is important to keep track of the number of copies of this document in circulation. When a recipient tries to make a print of this document, this event is again sensed and acquired, and the local Action Interpreter and Detector 20 might allow the printing, but keeps a record of the user who gave the print command and the number of copies made. Each page of the printed document contains the sensitive document ID [SDID] which can be read by other electronic devices, such as photocopy machines, scanners, fax machines, shredders, etc. The Action Interpreter and Detector on the photocopy machine assigns these copies against the user's record, in own its dedicated database, and also sends this information to the centralized Action Interpreter and Detector. The centralized AID 20 updates this information in the user array in the Identity Database by adding a new SDID column in the array [or increasing the number of copies against a particular SDID if the user is creating more copies of a document s/he possesses]. This record keeping is used to minimize the threat which could arise from a savvy hacker trying to distort the information in the local Action Interpreter and Detector.

A restriction can be imposed such that sensitive documents are printed only on a special paper and such that each printed copy of such a document is provided with a sensitivity indicating SDID. When this document is taken for photocopying, the photocopy machine authenticates the user (such as by use of a password, and access card, a biometric reader, etc.) and sends this event data to the Action Interpreter and Detector 20, which checks the level of sensitivity of the document and the credentials of the user to determine whether the user has the authority to make a copy of a document of the corresponding sensitivity.

Beyond this, the Action Interpreter and Detector 20 could make a decision of either granting the permission to photocopy, revoking the same, or granting the permission with some conditions attached. These conditions, for example, might be informing the originator of that document by mail about the user who just created a copy. The Action Interpreter and Detector 20 keeps a record of this event as well.

The same process applies to scanning the hard copy of a document to create a soft copy. The Action Interpreter and Detector 20 keeps a record of that event well.

Now, the Action Interpreter and Detector 20 knows how many copies have been made or are in circulation, as well as the users who created these copies (this information has been updated in the User array of the Identity Database 16). When a user destroys a copy by shredding it, the shredding machine again authenticates the user, reads the SDID on the document, and sends this information to the Action Interpreter and Detector 20. The Action Interpreter and Detector 20 reduces the number of copies possessed by this user by one, against the corresponding SDID column in the user array in the Identity Database. In this manner, the number of copies of sensitive documents and the possessors of these copies are always known to the organization, and accountability can be established.

The Identity Database 16 integrated with the Human Resources database of an organization, such that any major change in a user's status {terminated, resigned, transferred, on long leave such as maternity leave, etc.) as indicated by the Human Resources database is immediately captured. For example, once the Human Resources database is updated, both the physical and logical access of the employee who is going for a three month sabbatical to another country could be temporarily revoked by the operator.

The event interpreter and detector 18 sends real time alarms to one or more of the alarm monitoring clients 18 so that security guards are provided with real time situational awareness and can take corrective action, if required.

The responder 24 is the controller which actuates the response mechanism (making grant/revoke access decisions) based on inputs from the mapper 22.

As can be understood from the above description, the action interpreter and detector 20 receives action data packets in real time from the sensors and detectors in the action/asset space 30 and/or the system space 32 and determines whether any action needs to be taken. For example, when there is an attempt to access the door, an access card reader in the system space 32 sends the information about this event by use of action data packets to the action interpreter and detector 20. The action interpreter and detector 20 sends an acknowledgement about the receipt of these data packets to the access control system. The action interpreter and detector 20 “interprets” this event by checking the credentials of the person seeking the access to determine whether the person is entitled to enter that particular door, and issues instruction to the responder 24 to revoke/grant access.

The local mapper 22 on a laptop may be arranged to determines its own physical coordinate, such as by using GPS, and assign the same physical coordinate to the user. Then, the logical coordinate of the user, which could be the user's password, would be just used to check the user identity. So, the mapping could be done at a local level.

Other architectures can be used. For example, the mapper 22 and the responder 24, instead of existing as separate entities (hardware and/or software), could be merged into a single entity. Similarly, the identity database 16 and the credentials management engine 14, instead of existing as separate entities (hardware and/or software), could be merged into a single entity.

The system 10 is different from prior security systems because, among other things, it uses both physical and logical coordinates of an event to facilitate access decision making such as whether to grant and/or revoke and/or deny access. Also, the action interpreter and detector 20 can be used to consider actions from logical security elements (firewall, IDN) into the system 10 so as to converge physical and logical security to a degree not heretofore known. For example, if it is observed that several files from one computer are being transferred to neighboring computers in a small time [it could be a virus attack], the action interpreter and detector 20 could be configured to send a command to the corresponding video camera to view to the location of the said computer. In addition, the exemplary architecture of FIG. 2 integrates not only physical security systems but integrates physical security elements with logical security elements. Furthermore, real time situational awareness is provided such that, if a user leaves his laptop unattended, the action interpreter and detector 20 understands this event as soon as the user goes outside the room (swipes his card on the door to exit) or goes beyond a certain range (such as 10 metres) and the action interpreter and detector 20 locks the laptop. Also, messaging alerts are provided such that, whenever a breach occurs, appropriate personnel are informed via a message, such as by way of a mobile phone or e-mail.

The following illustrates how the system 10 solves the problems presented by the eight possible scenarios discussed above. It needs to be borne in mind, however, that, unless mentioned otherwise, here we refer to the local Action Interpreter and Detector 20, local Mapper on the laptop. There is no pattern analysis engine on the laptop and the Action Interpreter and Detector 20 does not have access to the Central Identity Database of the organization, when not connected to the network. When the user shuts down his computer at the organization and swipes on his/her way out, the Centralized Mapper registers his physical coordinate as “Out of Office”. When the user checks out his laptop at the exit gate, the local Mapper on the laptop registers his coordinate as “Outside Office”—there would be a suitable mechanism to carry out this process. So, whenever the employee is at home/traveling, the Mapper on his/her laptop knows that s/he is out of office & vice versa.

In scenario 1, an employee, who has use of a company laptop, leaves it unattended at some place other than the office and has not logged on to the network. An unscrupulous person takes advantage and carries the laptop away. That person tries to open and log on to the laptop. The unscrupulous person attempts to log on to the corporate network over the internet.

In this scenario, it is assumed that the unscrupulous person has been able to obtain the employee's password. It is not possible to always avoid this situation because passwords can be hacked.

In the solution provided herein, the mapper 22 of the laptop checks a biometric sensor or reader for the biometric identity of the person who tries to gain access (thumb impression or face reading) and establishes that the person trying to log in is not the genuine user. Now, it is possible that the employee has permitted some other genuine users to use the laptop (employee's secretary, for example). The action interpreter and detector 20 of the laptop compares the received biometric input to corresponding data in the identity database 16 of all the genuine users. If there are no matches, the responder 24 revokes access. Beyond this, the responder 24 of the laptop can be configured to take additional actions such as, if the genuine user does not log in within 48 hours of this incident, the AID irretrievably deletes all information that has been stored on the laptop.

In case where the intruder uses the laptop to try to log on to the corporate network, however, and on verifying that it is not the genuine user, the mapper 22 allows a very short term access to the network (˜10 seconds) during which a message is sent by the action interpreter and detector 20 to the employee and to one or more of the alarm monitoring clients 18 identifying the IP address from which the login attempt is being made and thereafter suspends the connection and locks the laptop. Even if biometrics are not available, RFID is a good option→if the user's RFID tag is not close enough to the laptop, the local Mapper can determine that the physical coordinate of the genuine user is not the same as that of the employee. By integrating the minute user tag with a part of his/her body—such as with a finger ring or ornament on the body—the issue of users forgetting their credential near the computer while going away can be eliminated. Other conditions being satisfied, when the user goes away from the computer, it could be automatically locked and vice versa.

In scenario 2, an authorized user such as an employee, who has use of a company laptop, leaves the laptop unattended at a location other than the office (such as at home) while logged on to the company network. An unauthorized user, such as an intruder, takes advantage and tries to hack into the company's systems.

In the solution provided herein, the Mapper 22 compares the biometric identity of the unauthorized user who tries to gain access (such as by use of a thumb impression or face reading) as provided by a detector on the laptop with the identities stored in the identity database 16 and establishes that the biometric identity of the unauthorized user does not match with the biometric identity of any authorized users. Therefore, it revokes access. The Mapper 22 sends a message over the network to the employee [email/SMS . . . ] and an alarm to one or more of the alarm monitoring clients 18 identifying the IP address from which the login attempt is being made and thereafter suspends the connection and locks the laptop.

On the other hand, if the laptop is provided with a camera/RFID reader, as soon as the authorized user leaves the laptop and moves out of the field of view of the camera, the action interpreter and detector 18 of the laptop may be arranged to immediately lock the laptop. Unless the genuine user comes close to the laptop, access won't be granted.

In scenario 3, an authorized user, such as an employee who has use of a company laptop, leaves the laptop unattended at the office, but s/he has not logged on to the corporate network. An unauthorized user such as an intruder takes advantage and tries to carry away the laptop.

In the solution provided herein, if the network cable is then disconnected by an unauthorized user, without the RFID tag of the genuine user coming close to the laptop, as determined by the action interpreter and detector 20 so as to physically remove the laptop, the action interpreter and detector 20 raises an audible alarm and/or sends an alarm message wirelessly, if possible to one or more of the alarm monitoring clients 18.

Of course, if the laptop is provided with a camera in the system space 32, as soon as the authorized user leaves the laptop and moves out of the field of view of the camera, the action interpreter and detector 20 may be configured to immediately lock the laptop.

In a first aspect of scenario 4, an unauthorized user person tailgates a person, who has legitimate access to an office, into the office, finds an unattended and unlocked PC (common in most enterprises), and begins stealing information.

In the solution provided herein, the Centralized Mapper 22 suspends the connection and locks the computer as soon as the genuine user of the said PC leaves the room as his/her physical coordinate changes when s/he swipes on the way out—so the tailgater has no chance of logging in. If the PC is RFID/Biometric enabled, this suspension happens as soon as the user moves out of the field of view of the reader.

The degree of detail in which a physical coordinate is described depends on context and requirements. For example, if an employee has swiped an access card at room #4 on the 3^{rd} floor of building A inside the premises of Organization B, the employee's physical coordinate could be, for example, “Inside Main Campus Building A 3rd floor ∥ room #4.”

Now, in this case, a tailgater's physical coordinate would be, for example, “Inside Main Campus Building A”. It may be assumed that there is a room, for example room #3, which is located in this building A in which the tailgater does not have access, but gains access by tailgating. If the tailgater tries to log on to a computer using the tailgater's own password, the Centralized action interpreter and detector 20 would send the tailgater's physical coordinate [“Inside Main Campus Building A”] and that of the particular computer [or any other logical object] to the Centralized Mapper 22. The latter physical coordinate may be, for example, “Inside Main Campus | Building A ∥ 4^{th} floor room #3”. Since the physical coordinates of the tailgater and the computer do NOT match, the mapper 22 revokes access and possibly implements other responses depending on company policy, such as lock the exits to isolate the intruder etc.

In another case, it is also possible that the tailgater has previously obtained the genuine user's password to that computer and uses that logical coordinate instead of the tailgater's own. In this case, if the genuine user has left the room, swiping the genuine user's access card on the way out, thus changing the genuine user's physical coordinate from “Inside Main Campus | Building A 14 floor room #3” to “Inside Main Campus |Building A”. However, the physical coordinate of the computer remains “Inside Main Campus | Building A ∥ 4^{th} floor ∥ room #3.” Thus, the physical coordinate of the user and the physical coordinate of the computer do not match again and an appropriate response is effected.

Of course, if the laptop is provided with a camera in system space 32, as soon as the authorized user leaves the laptop and moves out of the field of view of the camera, the action interpreter and detector 20 may be arranged to immediately lock the laptop. If the tailgater then tries to access the network using his own credentials, the action interpreter and detector 20 uses the identity database 16 and the credentials set by the credentials management engine 14 to determine that the tailgater does not possess a logical coordinate for the asset (no password to access this machine). Therefore, the responder 24 revokes access and/or generates an alarm and/or sends a message to the authorized user's mobile phone and/or to the authorized user's e-mail address and/or to one or more of the alarm monitoring clients 18 that a breach has occurred.

In a second aspect of scenario 4, an authorized user breaks into a room (such as at night) to steal information from unattended workstations.

In the solution provided herein, the action interpreter and detector 20 understands from intrusion detectors in the action/asset space 30 and/or the system space 32 that an unauthorized event has occurred (e.g., a glass break sensor detects breakage of glass) and bypasses the mapper 22 to inform the responder 24 to lock all computers.

In a second aspect of scenario 4, an authorized user such as an employee has entered an office and logged on to the corporate network, but went out for a cup of coffee. An unauthorized user such as an intruder remotely logs in (from outside the corporate network, or within the corporate network but outside this facility) through the firewall and tries to take out files.

In the solution provided herein, the action interpreter and detector 20 detects the events and the mapper 22 understands that the authorized user is in the office and has logged in from the room, but has gone out for a while (for example, the authorized user has not used the computer for some time or the authorized user has swiped himself out of the room—but he is still somewhere in office). The mapper 22 calls the list of all other genuine users of this machine (employee's secretary, etc.) and maps their locations. If all other genuine users are also present in the office but are attending their own other computers or are not in the room in which the unauthorized user is attempting to use the computer, the responder 24 revokes access to the computer and sends an alarm message as described above. However, if another authorized user is logging through remotely, he/she is granted access after prompting for a separate remote login password.

Of course, for those computers provided with a camera/RFID readers, as soon as the authorized user leaves the computer and moves out of the field of view of the camera as detected by the action interpreter and detector 20, the responder 24 immediately locks the computer, so physical usage of the computer by someone else is ruled out.

If the authorized user, in this scenario, tries to log on remotely to his laptop (such as when he needs some files from a conference room), then the mapper 22 maps the relevant coordinates again (the authorized user is in the conference room and is trying to login through a port in the conference room) and based on this mapping grants access. Basically, the Mapping process established that the user is present at the position from where a remote login query is being sent.

In scenario 5, the authorized user leaves work for home carrying his/her laptop, and on the way an unauthorized user picks up the laptop from the authorized user's car and walks away with it.

This scenario is dealt with similarly to scenario 1 as described above.

In both scenarios 1 and 5, the laptop is essentially stolen. A mechanism similar to mobile phones can be provided by which, whenever a successful attempt to log on to the network is made, instructions could be sent to the laptop to deactivate itself permanently.

In scenario 6, an authorized user is working from home and is logged on to the network. A hacker tries to remotely access the laptop of the authorized user.

The Mapper 22 immediately revokes access to the remote user as the employee is working having logged on based on physical/logical coordinates mapping. It is possible that another genuine user is trying to log in, so the laptop can prompt the employee about whether to grant access to the other user.

In scenario 7, an authorized user is working in office on the laptop without logging on to the network. This scenario is probably the safest mode of working and does not require any security measure.

If the laptop is provided with a camera, the action interpreter and detector 20 continuously monitors the working employee and, if the employee moves out of the field of view of the camera, the responder 24 locks the laptops.

In scenario 8, an authorized user is working on his laptop logged on to the network in office and an unauthorized user tries to, over the network, steal the files stored on the computer.

The action interpreter and detector 20 detects an attempted access to files while the authorized user is working on the laptop, and the mapper 22 detects this difference between the physical and logical coordinates of the authorized user and the logical coordinate of the unauthorized user to cause the responder 24 to immediately revoke access to the remote unauthorized user as the authorized user is working. In the event that a second authorized user is trying to log in, the laptop can prompt the first authorized user about whether to grant access to the second authorized user.

In this manner, the suggested architecture and the enhancements built into the machines (camera with video analytics, etc.) can safeguard valuable company information from all possible threat scenarios.

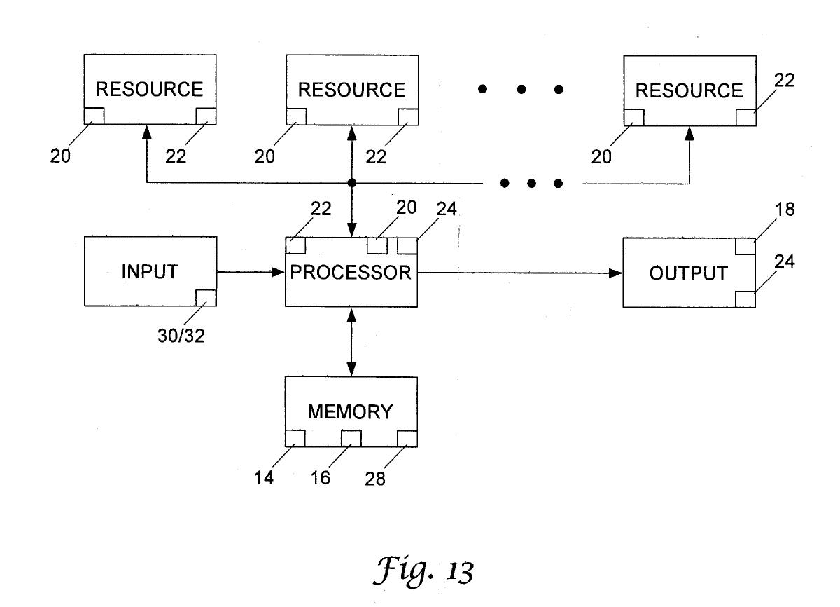

As indicated above, the action interpreter and detector 20, the mapper 22, and the responder 24 of the system 10 may be centralized. FIG. 13 shows a computer system 40 that can be used for this centralized approach. The computer 40 includes a processor 42, a memory 44, an input devices 36, and an output devices 48.

The input devices 46 would include the usual computer input devices such as a mouse and a keyboard. However, the input devices 46 would also include the detectors and sensors in the action/asset space 30 and/or the system space 32.

The output devices 48 would include the usual computer output devices such as a printer and a monitor. However, the output devices 48 would also include the alarm monitoring clients 18 and the responder 24.

The memory 44 includes the identity database 16, the credentials management engine 14, the dedicated memory and database 28, and can also include other databases as desired. In addition, the memory 44 can store applications that are appropriate to the system 10 and/or to other tasks to be run on the computer 40.

The processor 42 executes the action interpreter and detector 20, the mapper 22, and the responder 24. The action interpreter and detector 20, the mapper 22, and the responder 24 may be dedicated parts of the processor 42 or they may be routines executed by the processor 42 and stored in the memory 44.

The computer 40 is coupled over a network 40 to the resources that are to be protected by the system 10. As indicated above, these resources may include devices, data, facilities, etc.

Additionally or alternatively, the resources may be provided with the local action interpreter and detector 20 and the local mapper 22 as described above.

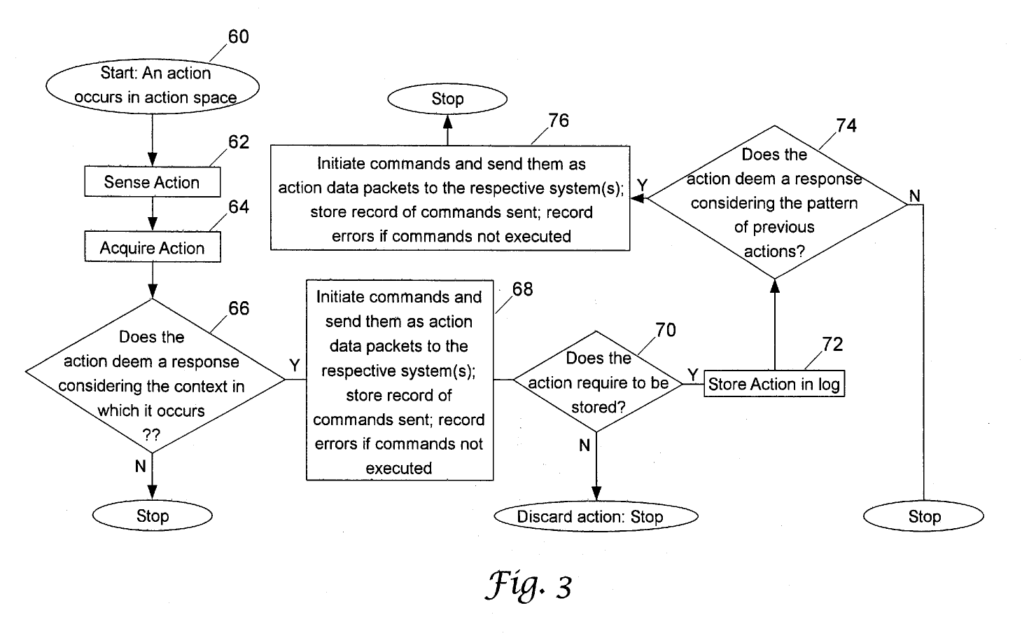

FIG. 3 illustrates in flow chart form the operation of the system 10. When an action occurs at 60 in the action/asset space 30, the action is sensed 62 by a detector or sensor in the system space 32. The event analysis engine 12 acquires the action at 64 and determines at 66 whether the action warrants a response. If not, process flow terminates.

However, if the event analysis engine 12 determines at 66 that the action warrants a response, the event analysis engine 12 at 68 initiates appropriate commands as discussed above and sends the commands as action data packets to the appropriate systems, as also discussed above. Moreover, the event analysis engine 12 stores a record of the commands, and further records any errors in the execution of the commands.

The event analysis engine 12 at 70 determines whether the action itself should be stored. If not, the action is discarded and process flow then terminates. However, if the event analysis engine 12 at 70 determines that the action itself should be stored, the event analysis engine 12 at 72 stores the action in a log.

The event analysis engine 12 at 74 then determines whether this stored action, in combination with other past actions, represents a pattern that warrants a response. If not, process flow terminates. However, if the event analysis engine 12 at 74 determines that this stored action, in combination with other past actions, represents a pattern that does warrants a response, the event analysis engine 12 at 76 initiates appropriate commands as discussed above and sends these commands as action data packets to the appropriate systems, as also discussed above. Moreover, the event analysis engine 12 stores a record of the commands, and further records any errors in the execution of the commands.

Certain modifications of the present invention have been discussed above. Other modifications of the present invention will occur to those practicing in the art of the present invention. Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

We claim:

1. A method of securing an asset implemented by a security system comprising:
detecting a physical coordinate corresponding to an action relating to an attempt to access the asset;
detecting a logical coordinate corresponding to an action relating to an attempt to access the asset;
mapping the physical coordinate and the logical coordinate; and,
controlling access to the asset in response to the mapping.

2. The method of claim 1 further comprising detecting an unauthorized transfer of a document from a first data carrying device to a second data carrying device.

3. The method of claim 2 wherein the document contains a document identifier, wherein the document identifier identifies an allowable usage of the document, and wherein the detecting of an unauthorized transfer of a document comprises detecting a use of the document contrary to the allowable usage identified by the document identifier.

4. The method of claim 1 further comprising detecting an unauthorized reproduction of information by monitoring actions involving the information.

5. The method of claim 1 further comprising tracking actions with respect to a document from creation of the document to either destruction or archiving of the document.

6. The method of claim 1 further comprising:
detecting a pattern from actions involving the asset based on policies governing the asset and based on a context of the actions;
determining access to the asset in response to the pattern.

7. The method of claim 1 further comprising continuously tracking a user as the user moves to and away from the asset.

8. The method of claim 1 further comprising transmitting information in data packets including an action ID and a system ID, wherein the action ID identifies an action taken by a user with respect to the asset, and wherein the system ID identifies a system interacting with the asset with respect to the action.

9. The method of claim 8 wherein the data packets further include the logical coordinate.

10. A security architecture comprising:
a database that stores information about the systems to which users have access and the privileges Of the users with respect to those systems; and
an event analysis engine, wherein the event analysis engine acquires several tangible actions occurring in an action space, wherein the actions relate to access to assets and reproduction of information, wherein the event analysis engine evaluates the acquired actions based on the information stored in the database and in context of past actions which have occurred, and wherein the event analysis engine determines a suitable response to the acquired action based on the evaluation.

11. The security architecture of claim 10 wherein the event analysis engine comprises a mapper, wherein the mapper correlates physical and logical coordinates, wherein the physical coordinate corresponds to one of the actions related to an attempt to access one of the assets, and wherein the logical coordinate corresponds to an action relating to an attempt to access the one asset.

12. The security architecture of claim 10 wherein the event analysis engine comprises an action interpreter and detector, wherein the action interpreter and detector interprets the actions based on information stored in the database to determine whether the actions are authorized.

13. The security architecture of claim 10 wherein the event analysis engine comprises a pattern analysis engine, wherein the pattern analysis engine uses a current action with past actions to detect a pattern indicating whether the current and past actions relate to authorized behavior of a user with respect to the assets.

14. The security architecture of claim 10 wherein the event analysis engine is arranged to detect an unauthorized transfer of a document from a first data carrying device to a second data carrying device.

15. The security architecture of claim 14 wherein the document contains a document identifier, wherein the document identifier identifies an allowable usage of the document, and wherein the event analysis engine is arranged to detect an unauthorized transfer of a document by detecting a use of the document contrary to the allowable usage identified by the document identifier.

16. The security architecture of claim 10 wherein the event analysis engine is arranged to detect an unauthorized reproduction of information by monitoring actions involving the information.

17. The security architecture of claim 10 wherein the event analysis engine is arranged to track actions with respect to a document from creation of the document to either destruction or archiving of the document.

18. The security architecture of claim 10 wherein the event analysis engine is arranged to detect a pattern from actions involving the asset based on policies governing the asset and based on a context of the actions and to determine access to the asset in response to the pattern.

19. The security architecture of claim 10 wherein the event analysis engine is arranged to continuously track a user as the user moves to and away from the asset.

20. The security architecture of claim 10 wherein the event analysis engine is arranged to transmit information in data packets including an action ID and a system ID, wherein the action ID identifies an action taken by a user with respect to the asset, and wherein the system ID identifies a system interacting with the asset with respect to the action.

21. The security architecture of claim 20 wherein the data packets further include the logical coordinate.

22. A method of protecting the transfer of a document from a first data carrying device to a second data carrying device comprising:
monitoring an action of a user with respect to an attempt to transfer the document from the first data carrying device to the second data carrying device;
determining whether the user is authorized to make the transfer based credentials of the user and a usage code on the document;
permitting the transfer if the user is authorized and preventing the transfer if the user is not authorized.

23. The method of claim 22 further comprising:
mapping physical and logical coordinates of the user and at least one of the first and second data carrying device;
permitting the transfer if the user is authorized and if the physical and logical coordinates properly map to one another; and,
preventing the transfer either if the user is not authorized or if the physical and logical coordinates improperly map to one another.
